(19) United States
(12) Patent Application Publication
(10) Pub. No.: US 2014/0247440 A1
(43) Pub. Date: Sep. 4, 2014

(54) MIRROR ACTUATOR, BEAM IRRADIATION DEVICE, AND LASER RADAR

(71) Applicant: SANYO Electric Co., Ltd., Osaka (JP)

(72) Inventor: Masato YAMADA, Aichi (JP)

(73) Assignee: SANYO Electric Co., Ltd., Osaka (JP)

(21) Appl. No.: 14/280,120

(22) Filed: May 16, 2014

Related U.S. Application Data
(63) Continuation of application No. PCT/JP2012/073037, filed on Sep. 10, 2012.

(30) Foreign Application Priority Data
Nov. 30, 2011 (JP) 2011-261628

(51) Int. Cl. G02B 26/10; G01S 17/06

(52) U.S. Cl. CPC G02B 26/101; G01S 17/06
USPC 356/5.01; 359/200.7; 359/200.1

(57) ABSTRACT

A mirror actuator includes: a base; a first rotation portion that is supported on the base so as to be rotatable about a first rotation axis; a second rotation portion that is supported on the first rotation portion so as to be rotatable about a second rotation axis perpendicular to the first rotation axis; a mirror disposed at the second rotation portion; a first drive portion that rotates the first rotation portion around the first rotation axis; and a second drive portion that rotates the second rotation portion around the second rotation axis. The second drive portion has a coil part and a magnet part applying a magnetic field to the coil part. One of the coil part and the magnet part is disposed at the first rotation portion, and the other is disposed at the second rotation portion.

This application claims priority under 35 U.S.C. Section 119 of Japanese Patent Application No. 2011-261628 filed Nov. 30, 2011, entitled “MIRROR ACTUATOR, BEAM IRRADIATION DEVICE, AND LASER RADAR”. The disclosure of the above application is incorporated herein by reference.

### BACKGROUND OF THE INVENTION

1. Field of the Invention

The present invention relates to a mirror actuator for rotating a mirror on two shafts as rotation axes, and a beam irradiation device and a laser radar with the mirror actuator.

2. Disclosure of Related Art

In recent years, laser radars have been used to monitor the status of a target region. A laser radar generally scans a target region with laser light and detects the presence or absence of an object at each of scan positions by the presence or absence of light reflected from each of the scan positions. Further, the laser radar detects a distance from the laser radar to the object based on a time taken from the timing when laser light is irradiated to each of the scan positions to the timing when reflected light is received.

As an actuator for scanning a target region with laser light, a moving coil-type mirror actuator with a mirror rotating about two shafts as rotation axes can be used, for example. In the case of such a mirror actuator, laser light enters the mirror from an oblique direction. When the mirror rotates horizontally and vertically about the two shafts as rotation axes, the laser light is swung horizontally and vertically in the target region.

In the case of using the foregoing mirror actuator in which the mirror rotates about the two shafts as rotation axes, one rotation of the mirror is prone to exert influence on the other rotation of the mirror. For example, the mirror actuator may be configured such that the mirror rotates in the directions of the two shafts by coils attached to one square frame member and a magnet disposed outside each of the coils. In this configuration, when the mirror rotates in one direction, the coil for rotating the mirror in the other direction integrally rotates. This causes a shift in position between the coil attached to the frame member and the magnet outside the coil, and thus the one rotation of the mirror may exert an adverse effect on the other rotation of the mirror.

### SUMMARY OF THE INVENTION

A first aspect of the present invention relates to a mirror actuator. The mirror actuator according to the first aspect includes: a base; a first rotation portion that is supported on the base so as to be rotatable about a first rotation axis; a second rotation portion that is supported on the first rotation portion so as to be rotatable about a second rotation axis perpendicular to the first rotation axis; a mirror disposed at the second rotation portion; a first drive portion that rotates the first rotation portion around the first rotation axis; and a second drive portion that rotates the second rotation portion around the second rotation axis. The second drive portion has a coil part and a magnet part applying a magnetic field to the coil part. One of the coil part and the magnet part is disposed at the first rotation portion, and the other is disposed at the second rotation portion.

A second aspect of the present invention relates to a beam irradiation device. The beam irradiation device according to the second aspect includes the mirror actuator according to the first aspect and a laser light source that supplies laser light to the mirror of the mirror actuator.

A third aspect of the present invention relates to a laser radar. The laser radar according to the third aspect includes: the mirror actuator according to the first aspect; a laser light source that supplies laser light to the mirror of the mirror actuator; a light-receiving portion that receives the laser light reflected from a target region; and a detection portion that detects an object in the target region based on output from the light-receiving portion.

### BRIEF DESCRIPTION OF THE DRAWINGS

The foregoing and other objects and new features of the present invention will be further completely understood from the following descriptions of embodiments in conjunction with the following attached drawings.

FIG. 1 is an exploded perspective view of a mirror actuator according to an embodiment;

FIG. 2 is an exploded perspective view of an inner unit of the mirror actuator according to the embodiment;

FIGS. 3A and 3B are perspective views of an inner unit frame according to the embodiment as seen from upper and lower sides, respectively;

FIGS. 4A and 4B are perspective views of a pan shaft according to the embodiment as seen from front and back sides, respectively;

FIG. 5A is a perspective view of a configuration of a pan magnet according to the embodiment, FIG. 5B is a perspective view of a configuration of a pan magnet holder according to the embodiment, and FIG. 5C is a perspective view of an assembled state of the pan magnet and the pan magnet holder according to the embodiment;

FIG. 6A is an exploded perspective view of a pan coil unit according to the embodiment as seen from the lower side, FIG. 6B is a perspective view of a pan coil holder according to the embodiment as seen from the upper side, and FIG. 6C is a perspective view of the pan coil unit according to the embodiment as seen from the upper side;

FIGS. 7A and 7B are perspective views of one suspension wire fixing board according to the embodiment as seen from the upper and lower sides, respectively, and FIGS. 7C and 7D are perspective views of the other suspension wire fixing board according to the embodiment as seen from the upper and lower sides, respectively;

FIGS. 8A to 8D are diagrams showing an assembly process of the inner unit according to the embodiment;

FIGS. 9A and 9B are perspective views of the assembled inner unit according to the embodiment as seen from the front and back sides, respectively;

FIG. 10A is an exploded perspective view of a configuration of an outer unit 20 according to the embodiment, FIG. 10B is a perspective view of a configuration of a tilt coil unit according to the embodiment, FIG. 10C is a perspective view of a configuration of a servo unit according to the embodiment, and FIG. 10D is a perspective view of a configuration of a pinhole box according to the embodiment;

FIG. 11A is an exploded perspective view of a configuration of a tilt shaft, a magnetic spring magnet holder, and a magnetic spring magnet according to the embodiment, and FIG. 11B is a perspective view of a combined state of the foregoing constituent members according to the embodiment;

FIGS. 12A and 12B are perspective views of the mirror actuator according to the embodiment as seen from front and back sides, respectively;

FIGS. 13A to 13D are diagrams showing operations of the rotating mirror actuator according to the embodiment;

FIGS. 14A to 14D are diagrams showing positional relationship between the pan magnet and the pan coil during rotation of the mirror actuator according to the embodiment;

FIGS. 15A and 15B are diagrams showing positional relationship between the pan magnet and the pan coil during rotation of the mirror actuator according to the embodiment;

FIGS. 16A and 16B are diagrams for describing a configuration and operations of a servo optical system according to the embodiment;

FIG. 17 is a diagram of a circuit configuration of a laser radar according to the embodiment; and

FIGS. 18A to 18D are diagrams of configurations of a mirror actuator according to a modification example.

However, the drawings are provided only for description but do not limit the scope of the present invention.

### DESCRIPTION OF PREFERRED EMBODIMENTS

In this embodiment, an inner unit frame 11 corresponds to a “first rotation portion” described in the claims. A pan shaft 12 corresponds to a “second rotation portion or a shaft part” described in the claims. Pan magnets 131 and 141 correspond to a “magnet part or magnet” described in the claims. Pan coil units 17 and 18 correspond to a “coil part” described in the claims. Pan coils 171 and 181 correspond to a “coil” described in the claims. An actuator frame 21 corresponds to a “base” described in the claims. A projection unit 400 corresponds to a “beam irradiation device” described in the claims. The foregoing correspondences in description between the claims and this embodiment are mere examples and do not limit the claims to this embodiment.

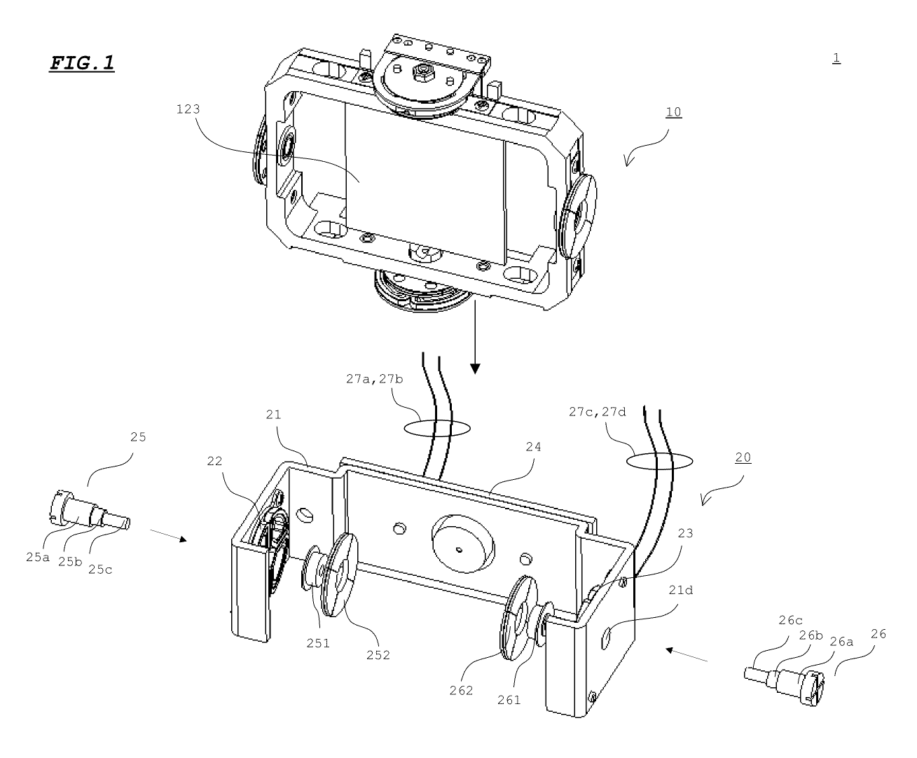

FIG. 1 is an exploded perspective view of a mirror actuator 1 according to this embodiment. As shown in FIG. 1, the mirror actuator 1 includes an inner unit 10 and an outer unit 20.

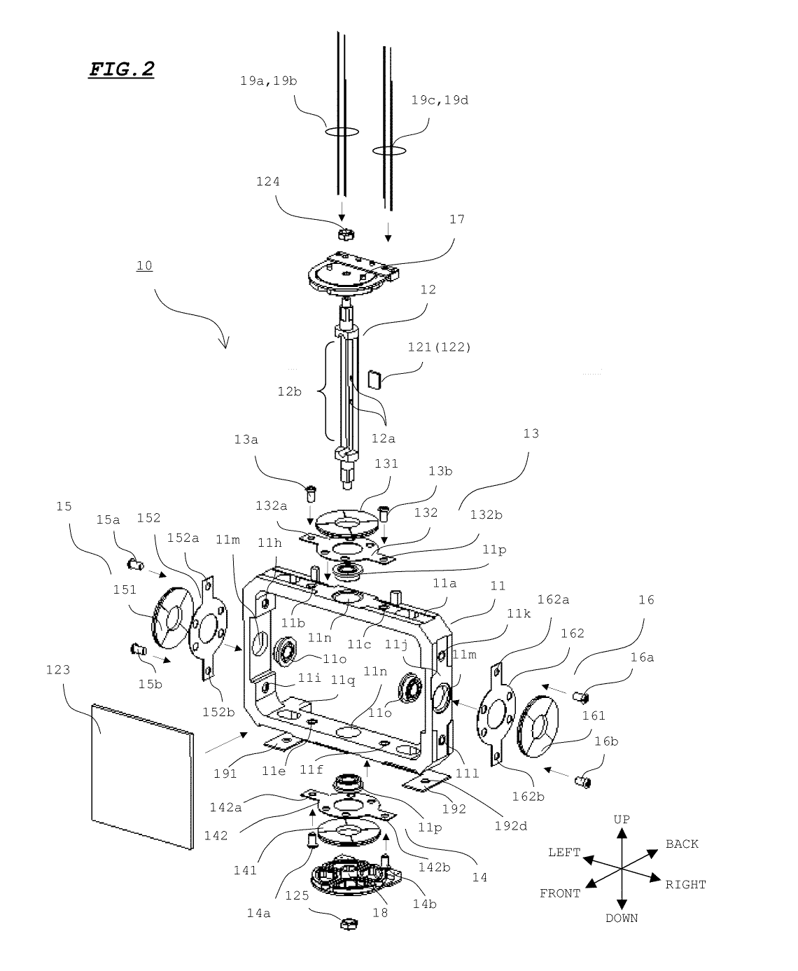

FIG. 2 is an exploded perspective view of the inner unit 10 of the mirror actuator 1. As shown in FIG. 2, the inner unit 10 includes an inner unit frame 11, a pan shaft 12, pan magnet units 13 and 14, tilt magnet units 15 and 16, pan coil units 17 and 18, and suspension wires 19a to 19d.

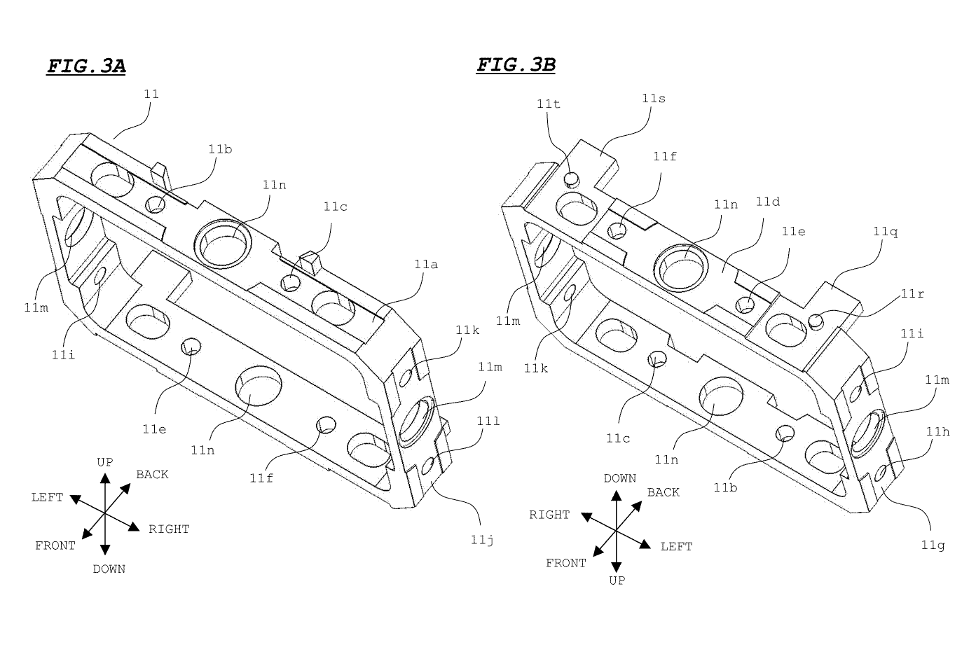

FIGS. 3A and 3B are perspective views of the inner unit frame 11 as seen from the upper and lower sides, respectively.

The inner unit frame 11 is formed by a frame member with rectangular contours in a front view. The inner unit frame 11 is made of light-weight resin or the like. The inner unit frame 11 also has a bilaterally symmetric shape.

The inner unit frame 11 has on an upper surface thereof a magnet attachment groove 11a for attachment of a pan magnet 131. The magnet attachment groove 11a has screw holes 11b and 11c to fix a tilt magnet holder 152. Similarly, the inner unit frame 11 has on a lower surface thereof a magnet attachment groove 11d for attachment of a pan magnet 141. The magnet attachment groove 11d has screw holes 11e and 11f to fix a pan magnet holder 142. The inner unit frame 11 has on a left surface thereof a magnet attachment groove 11g for attachment of a tilt magnet 151. The magnet attachment groove 11g has screw holes 11h and 11i to fix a tilt magnet holder 152. Similarly, the inner unit frame 11 has on a right surface thereof a magnet attachment groove 11j for attachment of a tilt magnet 161. The magnet attachment groove 11j has screw holes 11k and 11l to fix a tilt magnet holder 162.

The inner unit frame 11 also has horizontally aligned shaft holes 11m and vertically aligned shaft holes 11n. The shaft holes 11m are positioned in the middles of the right and left surfaces, and the shaft holes 11n are positioned in the middles of the upper and lower surfaces.

The inner unit frame 11 further has a flange part 11q at the left end on the bottom surface thereof. The flange part 11q has a convex portion 11r on the back surface (lower side) thereof. Similarly, the inner unit frame 11 has a flange part 11s at the right end on the bottom surface thereof. The flange part 11s has a convex portion 11t on the back surface (lower side) thereof.

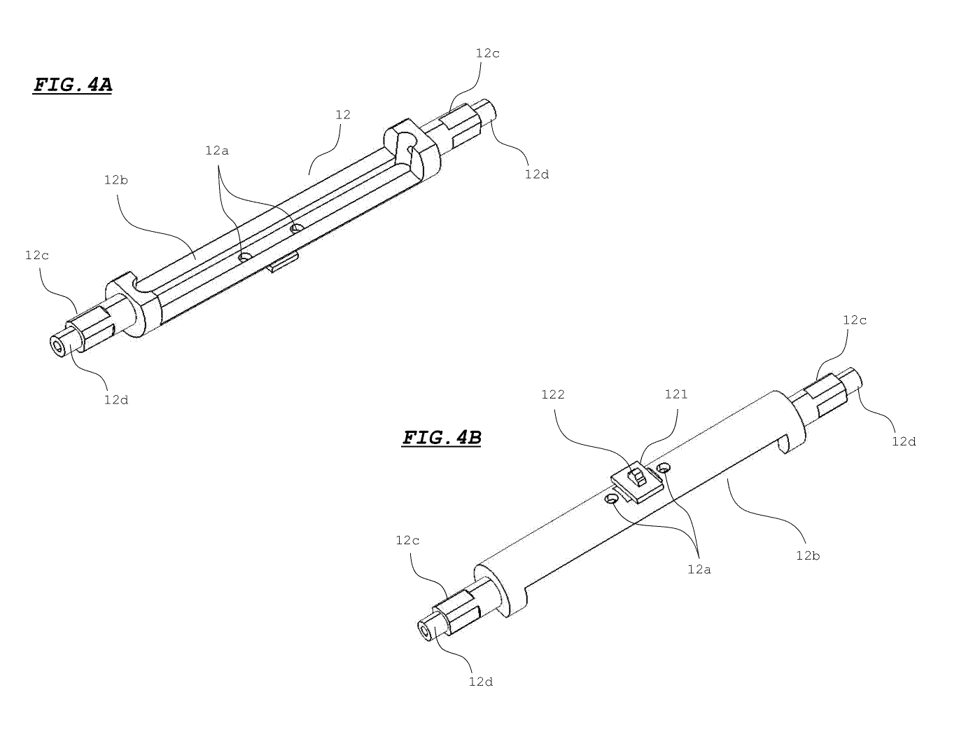

FIGS. 4A and 4B are diagrams of configurations of the pan shaft 12. FIG. 4A is a perspective view of the pan shaft 12 as seen from the front side, and FIG. 4B is a perspective view of the pan shaft 12 as seen from the back side.

The pan shaft 12 has holes 12a through which conductive wires pass to electrically connect the pan coils 171 and 181 and an LED 122, and a step portion 12b into which a mirror 123 is fitted. The pan shaft 12 is hollowed out to let the conductive wires pass through to electrically connect the pan coils 171 and 181 and the LED 122. The pan shaft 12 has on both ends thereof a fit portion 12c with a circumferential surface cut out in a planar shape at four sections, and an end portion 12d continued to the fit portion 12c. The pan shaft 12 is used as a rotation axis about which the mirror 123 rotates in a Pan direction as described later.

The LED 122 is attached to the back side of the pan shaft 12. The LED 122 is a diffusion-type (wide-oriented type) that can diffuse light in a wide area. The light diffused from the LED 122 is used to detect a scanning position in a target region with scanning laser light, as described later. The LED 122 is attached to an LED substrate 121. The LED substrate 121 is attached to the pan shaft 12 from behind.

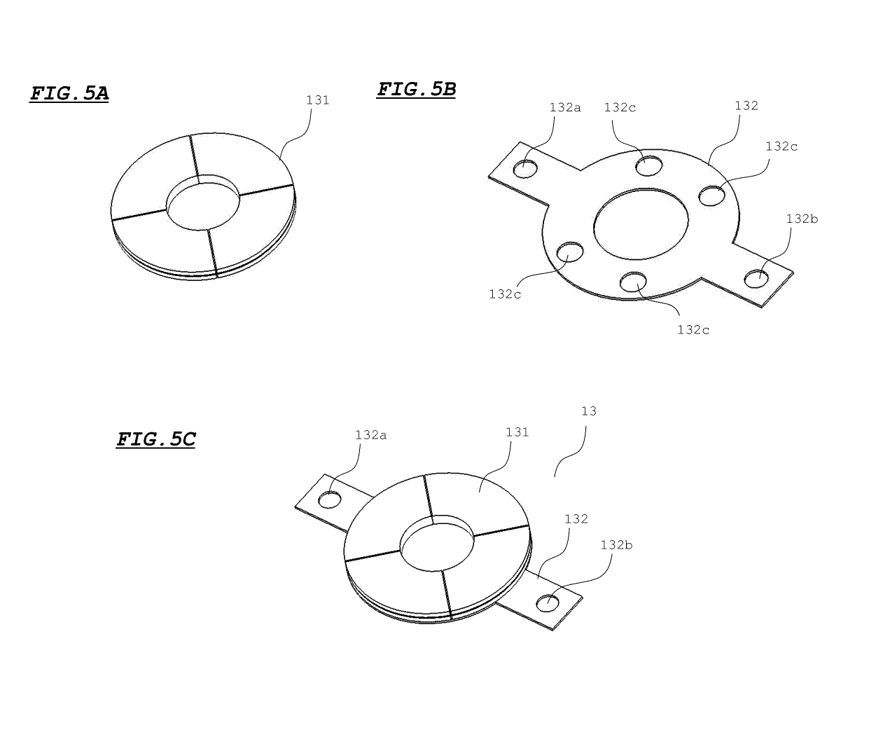

FIGS. 5A to 5C are diagrams of configurations of the pan magnet unit 13. FIG. 5A is a diagram of a configuration of the pan magnet 131, FIG. 5B is a diagram of a configuration of the pan magnet holder 132, and FIG. 5C is a diagram of an assembled state of the pan magnet 131 and the pan magnet holder 132.

The pan magnet unit 13 includes the pan magnet 131 and the pan magnet holder 132. The pan magnet 131 is almost circular in shape and is evenly divided into four sections in a circumferential direction. The pan magnet 131 is adjusted in polarity and placement such that, when an electric current is applied to the pan coil 171 (refer to FIG. 2) while the mirror actuator 1 is in the assembled state, a rotation force is generated around the pan shaft 12 as an axis. The pan magnet 131 has different polarities between adjacent sections.

The pan magnet holder 132 is formed by a magnetic body to enhance operations of a magnetic field generated on the pan magnet 131. The pan magnet holder 132 is attracted and fixed to the pan magnet 131. After completion of placement and adjustment of the pan magnet 131 with respect to the pan magnet holder 132, an adhesive is flown through four holes 132c formed in the pan magnet holder 132 to let the pan magnet 131 adhere and fix to the pan magnet holder 132. The pan magnet holder 132 has screw holes 132a and 132b for fixation to the inner unit frame 11.

The pan magnet unit 14 is configured in the same manner as the pan magnet unit 13, and includes a pan magnet 141 and a pan magnet holder 142 (refer to FIG. 2). The pan magnet holder 142 also has screw holes 142a and 142b.

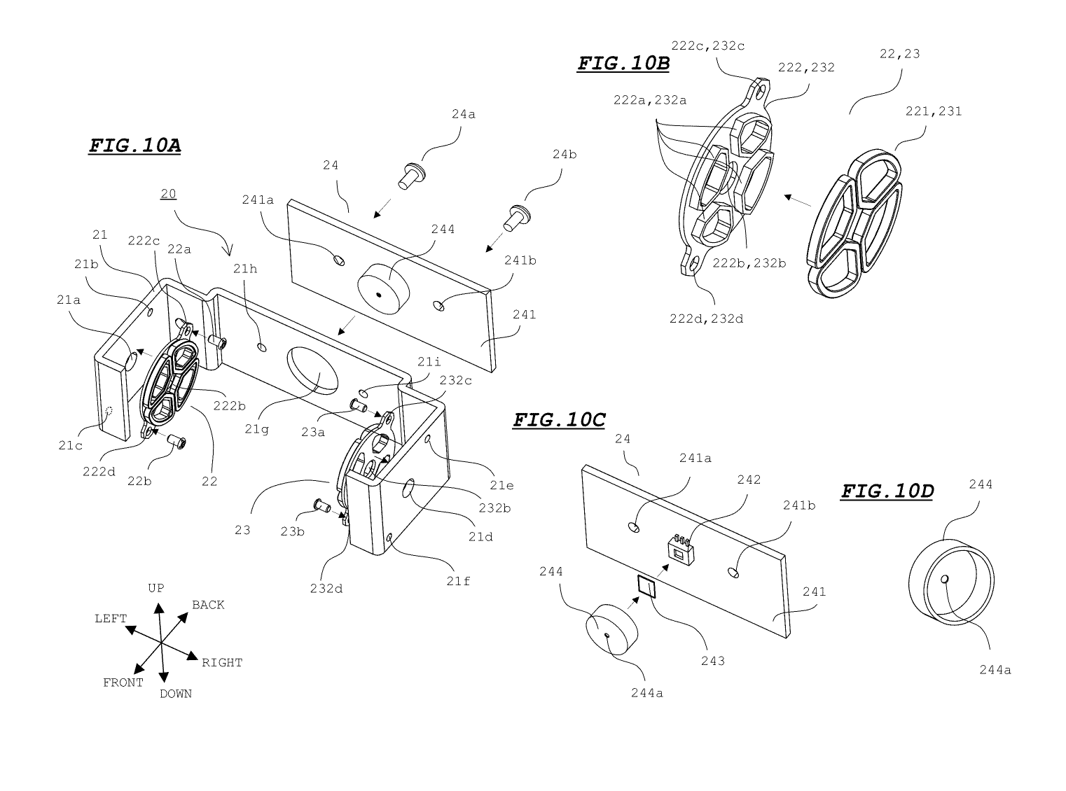

The tilt magnet unit 15 is configured in the same manner as the pan magnet unit 13 (refer to FIG. 2). The tilt magnet unit 15 includes a tilt magnet 151 and a tilt magnet holder 152. The tilt magnet 151 is almost circular in shape and is evenly divided into four sections. The tilt magnet 151 is adjusted in polarity and placement such that, when an electric current is applied to a tilt coil 221 (refer to FIG. 10B) while the mirror actuator 1 is in the assembled state, a rotation force is generated around the tilt shaft 25 (refer to FIG. 1) as an axis. The tilt magnet 151 has different polarities between adjacent sections.

The tilt magnet holder 152 is formed by a magnet body to enhance operations of a magnetic field generated on the tilt magnet 151. The tilt magnet holder 152 is attracted and fixed to the tilt magnet 151. After completion of placement and adjustment of the tilt magnet 151 with respect to the tilt magnet holder 152, an adhesive is flown through four holes formed in the tilt magnet holder 152 to let the tilt magnet 151 adhere and fix to the tilt magnet holder 152. The tilt magnet holder 152 has screw holes 152a and 152b for fixation to the inner unit frame 11.

The tilt magnet unit 16 is configured in the same manner as the tilt magnet unit 15, and includes a tilt magnet 161 and a tilt magnet holder 162. The tilt magnet holder 162 has also screw holes 162a and 162b.

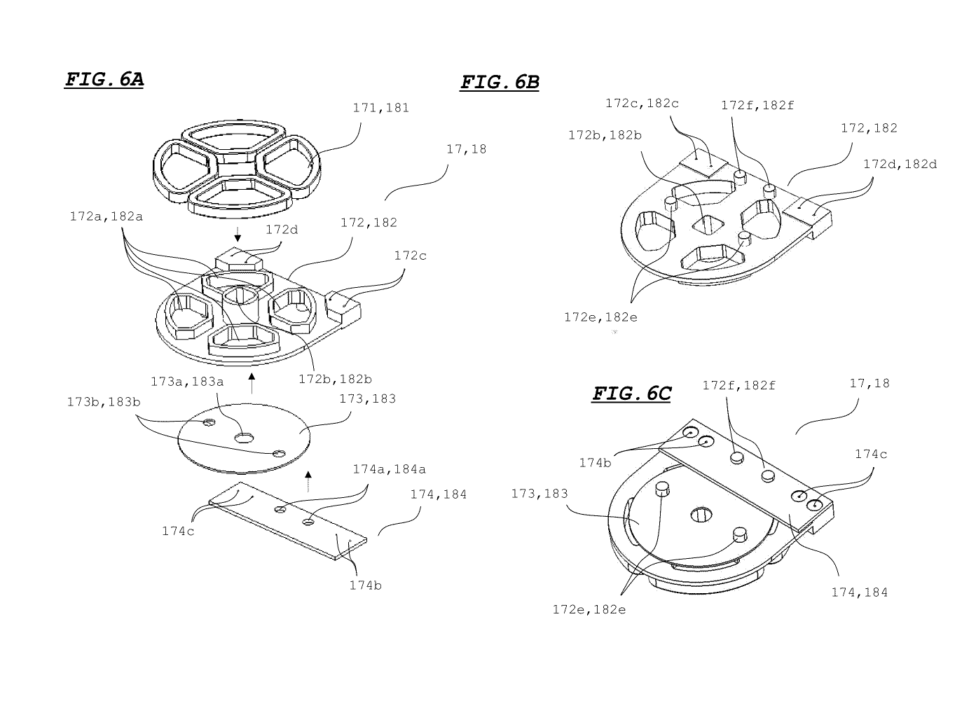

FIGS. 6A to 6C are diagrams of a configuration of the pan coil unit 17. FIG. 6A is an exploded perspective view of the pan coil unit 17 as seen from the lower side, FIG. 6B is a perspective view of a pan coil holder 172 as seen from the upper side, and FIG. 6C is a perspective view of the pan coil unit 17 as seen from the upper side. Since the configuration of the pan coil unit 18 is almost the same as that of the pan coil unit 17, FIGS. 6A to 6C has both numeral codes given to the components of the pan coil unit 17 and numeral codes given to the components of the pan coil unit 18 corresponding to the components of the pan coil unit 17. For the sake of convenience, the following description will be given as to the pan coil unit 17.

Referring to FIG. 6A, the pan coil unit 17 includes the pan coil 171, the pan coil holder 172, a yoke 173, and a suspension wire fixing board 174.

The pan coil holder 172 is made of a resin material. The pan coil holder 172 has four pan coil attachment portions 172a. The pan coil attachment portions 172a are each configured to have a wall around an almost fan-shaped opening penetrating in the vertical direction. The pan coils 171 are fixed to the four pan coil attachment portions 172a so as to be routed along the walls. The four pan coils 171 have the same shape of an almost fan. When the four pan coils 171 are attached to the corresponding pan coil attachment portions 172a, the entire outline of the pan coils 171 has an almost circular shape in a planar view. In this state, the four pan coils 171 are uniformly arranged in the circumferential direction such that the sides of the fan shapes are adjacent to each other. The four pan coils 171 are united and are adjusted in winding direction such that, when an electric current is flown into the assembled mirror actuator 1, electromagnetic drive forces are generated on the pan coils 171 in the same rotation direction.

The pan coil holder 172 has at a center thereof a shaft hole 172b through which the end portion 12d of the pan shaft 12 is passed. The shaft hole 172b has an outline of a square with round apexes in a planar view so as to fit with the fit portion 12c of the pan shaft 12. The yoke 173 has at a center thereof a shaft hole 173a through which the end portion 12d of the pan shaft 12 is passed. The yoke 173 enhances operations of a magnetic field of the opposed pan magnet 131.

The pan coil holder 172 has corners raised like a stage, and at the corners thereof two wire holes 172c through which the suspension wires 19a and 19b are passed and two wire holes 172d through which the suspension wires 19c and 19d are passed. The wire holes 172c and 172d vertically penetrate through the pan coil holder 172. The suspension wire fixing board 174 has the shape of a rectangular thin plate.

The suspension wire fixing board 174 is made of glass epoxy resin. The suspension wire fixing board 174 has two terminal holes 174b through which the suspension wires 19a and 19b are passed, and two terminal holes 174c through which the suspension wires 19c and 19d are passed, at positions corresponding to the wire holes 172c and 172d. The terminal holes 174b and 174c vertically penetrate through the suspension wire fixing board 174. In addition, as shown in FIG. 6C, the suspension wire fixing board 174 has on the upper surface thereof concave portions for placement of solder around the terminal holes 174b and 174c.

The pan coil holder 172 also has on the upper surface thereof cylinder convex portions 172e and 172f as shown in FIG. 6B. The yoke 173 has two holes 173b at positions corresponding to the convex portions 172e. By passing the convex portions 172e through the holes 173b, the yoke 173 is positioned on the pan coil holder 172. In this state, the yoke 173 is adhered and fixed to the upper surface of the pan coil holder 172.

The suspension wire fixing board 174 has two holes 174a formed at positions corresponding to the convex portions 172f. By passing the convex portions 172f through the holes 174a, the suspension wire fixing board 174 is positioned on the pan coil holder 172. In this state, the suspension wire fixing board 174 is adhered and fixed to the upper surface of the pan coil holder 172. Accordingly, the pan coil unit 17 is completed as shown in FIG. 6C.

In this state, the position of the shaft hole 172b of the pan coil holder 172 is aligned with the position of the shaft hole 173a of the yoke 173. In addition, the positions of the wire holes 172c of the pan coil holder 172 are aligned with the positions of the terminal holes 174b of the suspension wire fixing board 174, and the positions of the wire holes 172d of the pan coil holder 172 are aligned with the positions of the terminal holes 174c of the suspension wire fixing board 174.

The pan coil unit 18 is configured in almost the same manner as the pan coil unit 17. However, since the suspension wires 19a to 19d are not passed through a suspension wire fixing board 184 of the pan coil unit 18, the pan coil holder 182 is not provided with wire holes and the suspension wire fixing board 184 is not provided with terminal holes.

Returning to FIG. 2, the suspension wires 19a to 19d are made of phosphor bronze, beryllium copper, or the like, and are excellent in conductivity, and have elastic property. The suspension wires 19a to 19d each have a circular cross section. The suspension wires 19a to 19d have the same shape and the same characteristics, and are used to supply current to the pan coils 171 and 181 and the LED 122, and provide stable load during rotation of the mirror 123 in the Pan direction. The suspension wires 19a to 19d hardly expand or contract even when longitudinal forces are applied to the suspension wires 19a to 19d.

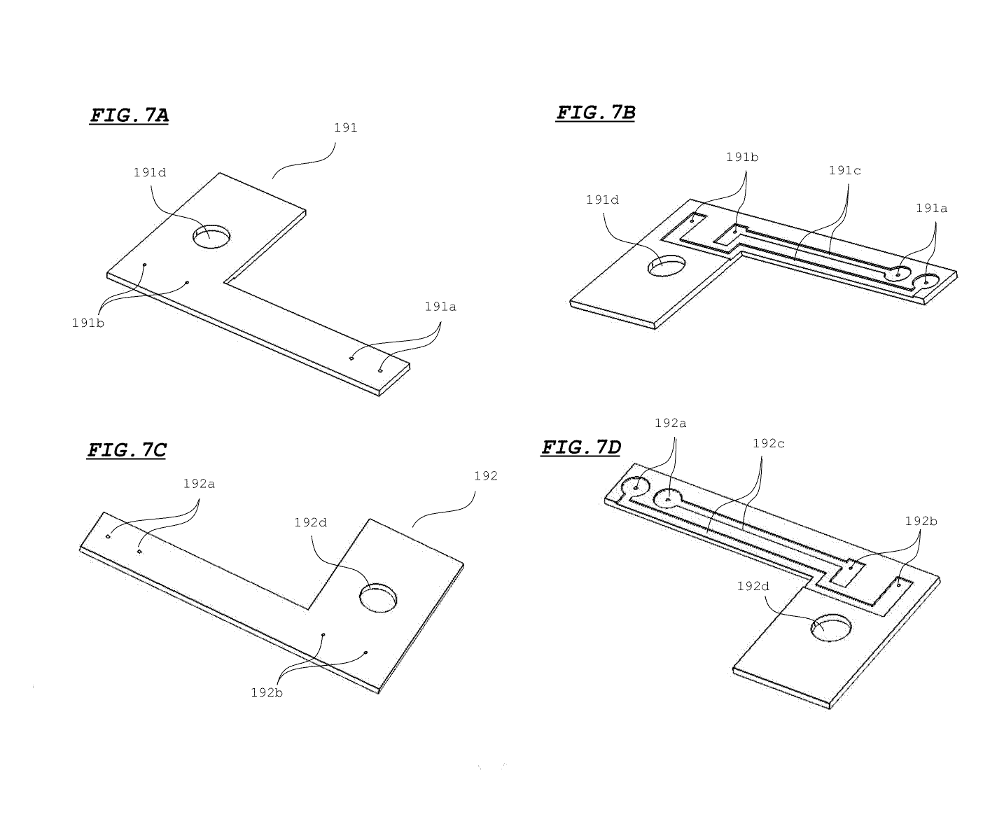

FIGS. 7A to 7D are diagrams showing configurations of suspension wire fixing boards 191 and 192. FIGS. 7A and 7B are perspective views of the suspension wire fixing board 191 as seen from the upper and lower sides, respectively. FIGS. 7C and 7D are perspective views of the suspension wire fixing board 192 as seen from the upper and lower sides, respectively.

Referring to FIG. 7A, the suspension wire fixing board 191 is a circuit board made of glass epoxy resin or the like and having flexibility. The suspension wire fixing board 191 has two terminal holes 191a through which the suspension wires 19a and 19b are passed, and two terminal holes 191b through which the suspension wires 27a and 27b are passed. The suspension wire fixing board 191 also has a circuit pattern 191c for electrically connecting the terminal holes 191a and the terminal holes 191b.

The suspension wire fixing board 191 also has a hole 191d. By passing the convex portion 11r (refer to FIG. 3B) formed on the bottom surface of the inner unit frame 11 through the hole 191d, the suspension wire fixing board 191 is adhered and fixed to the bottom surface of the inner unit frame 11.

The suspension wire fixing board 192 is bilaterally symmetrical to the suspension wire fixing board 191. Referring to FIGS. 7C and 7D, the suspension wire fixing board 192 has two terminal holes 192a, two terminal holes 192b, circuit patterns 192c, and a hole 192d. By passing the convex portion 11t (refer to FIG. 3B) formed on the bottom surface of the inner unit frame 11 through the hole 192d, the suspension wire fixing board 192 is adhered and fixed to the bottom surface of the inner unit frame 11.

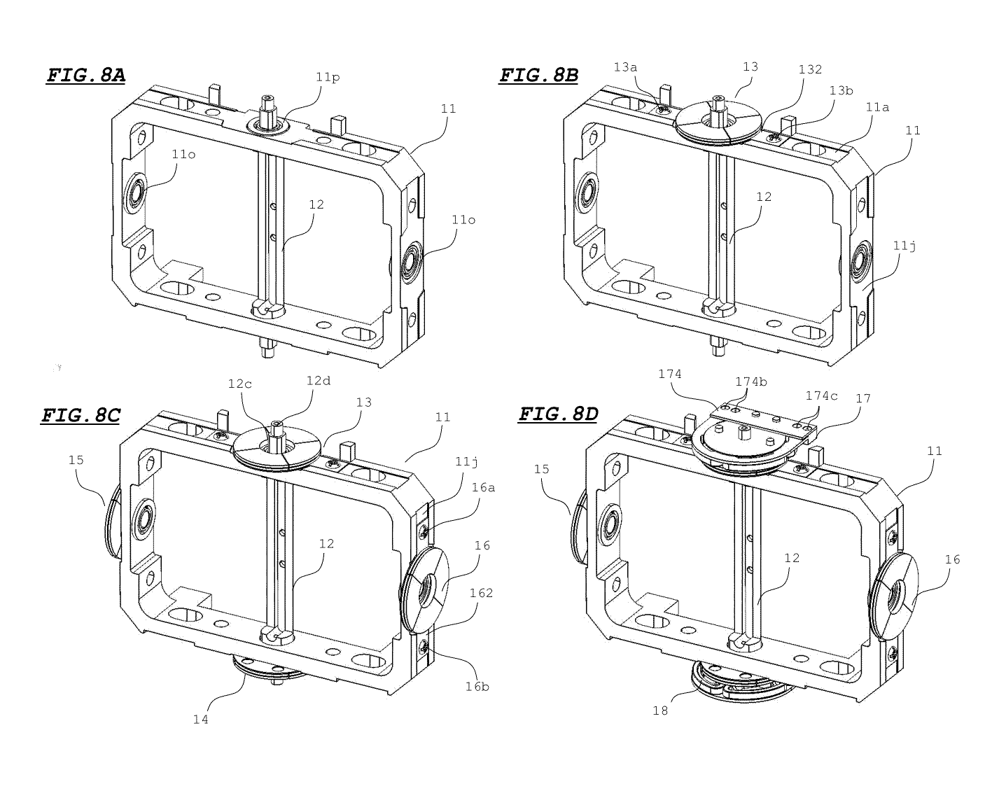

Referring to FIG. 2, to assemble the inner unit 10, first, the pan shaft 12 is passed through the shaft holes 11n and stored in the inner unit frame 11. Then, the mirror 123 is fitted into the step portion 12b of the pan shaft 12, and two bearings 11p are attached to the shafts at the both ends of the pan shaft 12. In this state, the two bearings 11p are fitted into the shaft holes 11n formed in the inner unit frame 11. In addition, two bearings 110 for the tilt shafts 25 and 26 are fitted into the shaft holes 11m formed in the inner unit frame 11. Accordingly, the assembly is completed as shown in FIG. 8A. In FIGS. 8A to 8D, the mirror 123 is not illustrated for the sake of convenience. In the state of FIG. 8A, the suspension wire fixing boards 191 and 192 are attached to the lower surface of the inner unit frame 11 as described above.

After that, as shown in FIG. 8B, the pan magnet holder 132 is fitted into the magnet attachment groove 11a of the inner unit frame 11, and the screw holes 132a and 132b and the screw holes 11b and 11c are aligned with one another. In this state, the screws 13a and 13b are screwed into the screw holes 11b and 11c through the screw holes 132a and 132b. Accordingly, the pan magnet unit 13 is fixed to the inner unit frame 11. Similarly, the pan magnet unit 14 is fixed to the inner unit frame 11 by the means of the screws 14a and 14b.

In addition, as shown in FIG. 8C, the tilt magnet holder 162 is fitted into the magnet attachment groove 11j of the inner unit frame 11, and the screw holes 162a and 162b and the screw holes 11k and 11l are aligned with one another. In this state, the screws 16a and 16b are screwed into the screw holes 11k and 11l through the screw holes 162a and 162b. Accordingly, the tilt magnet unit 16 is fixed to the inner unit frame 11. Similarly, the tilt magnet unit 15 is fixed to the inner unit frame 11 by the means of the screw 15a and 15b.

Next, the pan coil units 17 and 18 are passed through the fit portions 12c at the both ends of the pan shaft 12, and the pan coil units 17 and 18 are attached to the both ends of the pan shaft 12. Accordingly, the assembly is completed as shown in FIG. 8D. In addition, nuts 124 and 125 are attached to end portions 12d at both ends of the pan shaft 12, and thus the pan coil units 17 and 18 are fixed to the both ends of the pan shaft 12. Accordingly, the pan coil units 17 and 18 are rotatable integrally with the pan shaft 12.

In this state, the terminal holes 174b of the suspension wire fixing board 174 are opposed to the terminal holes 191a of the suspension wire fixing board 191, and the terminal holes 174c of the suspension wire fixing board 174 are opposed to the terminal holes 192a of the suspension wire fixing board 192. In addition, the suspension wires 19a and 19b are passed through the terminal holes 191a of the suspension wire fixing board 191 through the terminal holes 174b of the suspension wire fixing board 174 and the wire holes 172c of the pan coil holder 172. Similarly, the suspension wires 19c and 19d are passed through the terminal holes 192a of the suspension wire fixing board 192 through the terminal holes 174c of the suspension wire fixing board 174 and the wire holes 172d of the pan coil holder 172. The suspension wires 19a to 19d are soldered to the suspension wire fixing boards 174, 191, and 192 together with the conductive wires for supplying an electric current to the pan coils 171 and 181 and the LED 122.

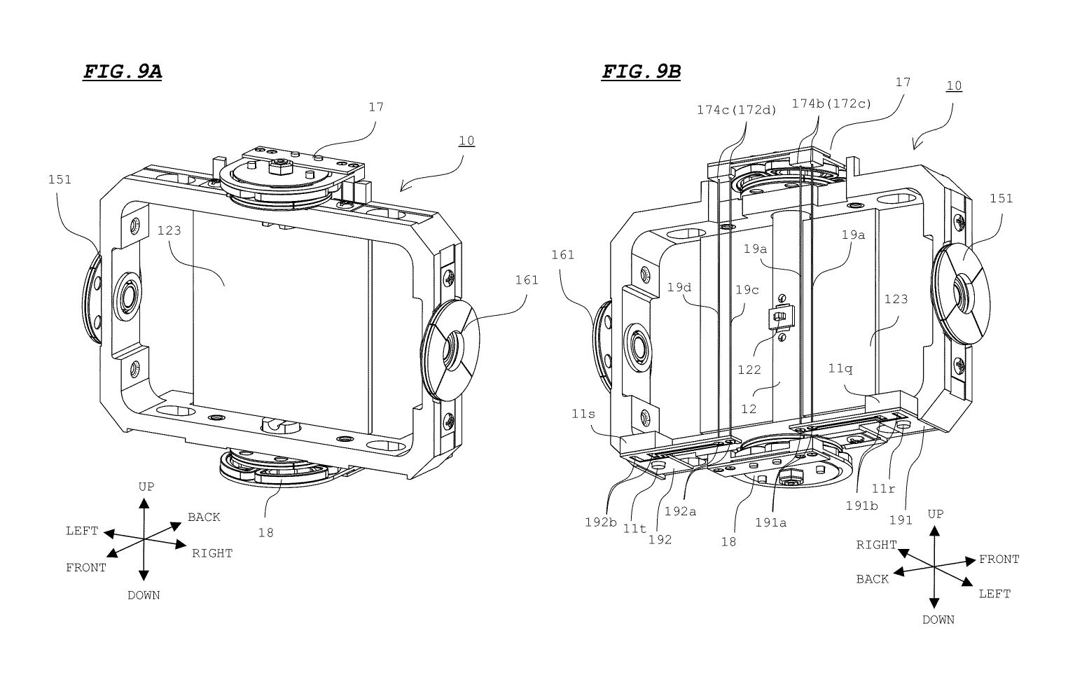

Accordingly, the inner unit 10 is completely assembled as shown in FIGS. 9A and 9B. FIG. 9A is a perspective view of the assembled inner unit 10 as seen from the front side, and FIG. 9B is a perspective view of the assembled inner unit 10 as seen from the back side. In this state, the mirror 123 is rotatable around the pan shaft 12 in the Pan direction. With the rotation of the mirror 123 in the Pan direction, the pan coil units 17 and 18 rotate in the Pan direction. On the other hand, the suspension wire fixing boards 191 and 192 are fixed to the lower surface of the inner unit 10, and thus do not rotate in the Pan direction with the rotation of the mirror 123 in the Pan direction.

Returning to FIG. 1, the outer unit 20 includes an actuator frame 21, tilt coil units 22 and 23, a servo unit 24, tilt shafts 25 and 26, and suspension wires 27a to 27d.

Referring to FIGS. 10A to 10D, the actuator frame 21 is formed by a frame member opened at the front side. The actuator frame 21 has at centers of right and left surfaces thereof shaft holes 21a and 21d through which the tilt shafts 25 and 26 are passed. The actuator frame 21 has on the right and left surfaces thereof screw holes 21b, 21c, 21e, and 21f for fixation of the tilt coil units 22 and 23. The actuator frame 21 also has on a back surface thereof an opening 21g through which a pinhole box 244 of the servo unit 24 is passed, and screw holes 21h and 21i for fixation of the servo unit 24.

FIG. 10B is a diagram showing a configuration of the tilt coil unit 22. The tilt coil unit 23 is the same in configuration as the tilt coil unit 22, and thus FIGS. 10A to 10D provide both reference numerals given to components of the tilt coil unit 22 and reference numerals of corresponding components of the tilt coil unit 23. In the following, the tilt coil unit 23 will be described for the sake of convenience.

Referring to FIG. 10B, the tilt coil unit 22 includes a tilt coil 221 and a tilt coil holder 222.

The tilt coil holder 222 is made of a resin material. The tilt coil holder 222 is provided with four tilt coil attachment portions 222a. The tilt coil attachment portions 222a are each configured to have a wall around an almost fan-shaped opening penetrating in the vertical direction. The tilt coils 221 are fixed to the four tilt coil attachment portions 222a so as to be routed along the walls. The four tilt coils 221 have the same shape of an almost fan. When the four tilt coils 221 are attached to the corresponding tilt coil attachment portions 222a, the entire outline of the tilt coils 221 has an almost circular shape in a planar view. In this state, the four tilt coils 221 are uniformly arranged in the circumferential direction such that the sides of the fan shapes are adjacent to each other. The four tilt coils 221 are united and are adjusted in winding direction such that, when an electric current is flown into the assembled mirror actuator 1, electromagnetic drive forces are generated between the tilt coils 221 and the tilt magnet unit 15 in the same rotation direction.

The tilt coil holder 222 has at a center thereof a circular shaft hole 222b through which the tilt shaft 25 is passed. The tilt coil holder 222 also has at both ends thereof screw holes 222c and 222d for fixation to the actuator frame 21.

The tilt coil unit 23 is configured in the same manner as the tilt coil unit 22. Thus, detailed descriptions of components of the tilt coil unit 23 will be omitted here.

Referring to FIG. 10C, the servo unit 24 includes a PSD board 241, a PSD 242, a bandpass filter 243, and a pinhole box 244.

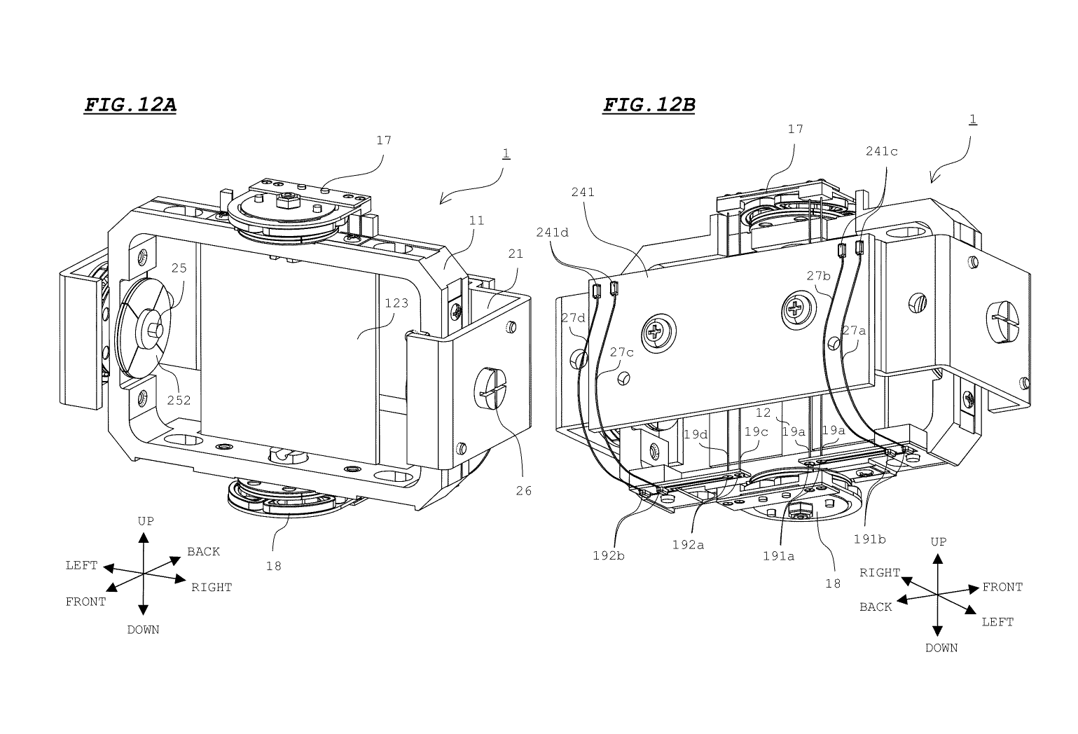

The PSD board 241 has two screw holes 241a and 241b for fixing the PSD board 241 to the actuator frame 21. The PSD board 241 has on a back surface thereof two terminal holes 241c (refer to FIG. 12B, not shown in FIG. 10C) through which the suspension wires 27a and 27b are passed. The PSD board 241 also has on the back surface thereof two terminal holes 241d (refer to FIG. 12B, not shown in FIG. 10C) through which the suspension wires 27c and 27d are passed. The PSD 242 is attached to the PSD board 241. The PSD 242 outputs a signal according to the light-receiving position of servo light.

The bandpass filter 243 lets only light at a wavelength band emitted from the LED 122 pass through, and eliminates stray light at other wavelength bands. The bandpass filter 243 is attached to the front surface of the PSD 242 and adhered and fixed to the PSD 242.

The pinhole box 244 is hollow and has a pinhole 244a at a center thereof as shown in FIG. 10D. The pinhole 244a allows a portion of diffusion light emitted from the LED 122 to pass therethrough. The pinhole box 244 is made of a light-blocking substance to prevent stray light other than the light passing through the pinhole 244a from entering the PSD 242. The pinhole box 244 is attached to the PSD board 241 and adhered and fixed to the PSD 241.

Returning to FIG. 10A, at assembly of the outer unit 20, first, the tilt coil units 22 and 23 are attached to the right and left surfaces of the actuator frame 21. In this state, the screws 22a and 22b are screwed into the screw holes 21b and 21c through the screw holes 222c and 222d. Accordingly, the tilt coil unit 22 is fixed to the actuator frame 21. Similarly, the screws 23a and 23b are screwed into the screw holes 21e and 21f through the screw holes 232c and 232d. Accordingly, the tilt coil unit 23 is fixed to the actuator frame 21.

Next, the PSD board 241 is attached to the back surface of the actuator frame 21. In this state, the screws 24a and 24b are screwed into the screw holes 21h and 21i through the screw holes 241a and 241b. Accordingly, the servo unit 24 is fixed to the actuator frame 21. Thus, the structure is assembled as shown in FIG. 1.

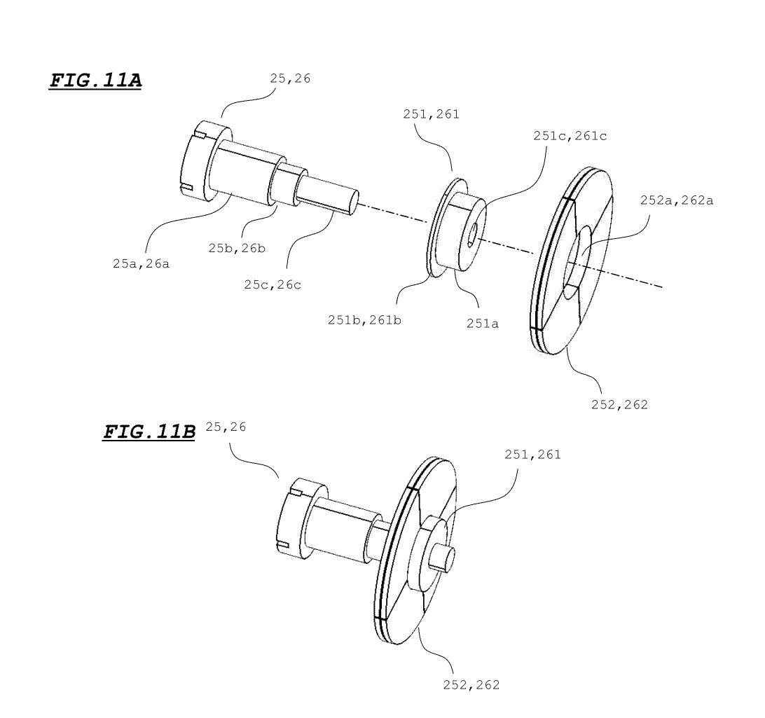

FIG. 11A is an exploded perspective view of a configuration of a magnetic spring magnet holder 251 and a magnetic spring magnet 252, and FIG. 11B is a perspective view of the foregoing components in the assembled state. A configuration of the tilt shaft 25, the magnetic spring magnet holder 251, and the magnetic spring magnet 252 is the same as the configuration of the tilt shaft 26, the magnetic spring magnet holder 261, and the magnetic spring magnet 262. Thus, for the sake of convenience, FIGS. 11A and 11B also have reference numerals for the corresponding components of the tilt shaft 26, the magnetic spring magnet holder 261, and the magnetic spring magnet 262.

The tilt shaft 25 is provided with a step portion 25a slightly smaller than the diameter of the shaft hole 21a of the actuator frame 21, a step portion 25b slightly smaller than the diameter of the bearings 110 of the inner unit frame 11, and a step portion 25c slightly smaller than the diameter of the magnetic spring magnet holder 251.

The magnetic spring magnet holder 251 is made of a hard material (for example, a resin material) so as not to be deformed even when a force is applied. The magnetic spring magnet holder 251 is provided with a cylinder barrel portion 251a, a flange portion 251b formed on a bottom surface of the barrel portion 251a, and a circular hole 251c penetrating through a center of the barrel portion 251a. The diameter of the hole 251c is almost the same as the diameter of the step portion 25c of the tilt shaft 25.

The magnetic spring magnet 252 is disc-shaped and has a circular hole 252a at a center thereof. The diameter of the hole 252a is slightly larger than the diameter of the barrel portion 251a of the magnetic spring magnet holder 251. The magnetic spring magnet 252 is evenly divided into four sections in the circumferential direction. The sections of the magnetic spring magnet 252 are adjusted in polarity such that, in the assembled state shown in FIGS. 12A and 12B, the sections are opposed to the tilt magnet 151 (refer to FIG. 2) and attracted to each other. In the assembled state shown in FIGS. 12A and 12B, the positions of the divided sections of the magnetic spring magnet 252 are decided in correspondence with the positions of the divided sections of the tilt magnet 151 (refer to FIG. 5A).

The magnetic spring magnet 252 is adhered and fixed to the magnetic spring magnet holder 251 while the hole 252a is fitted onto the barrel portion 251a and the bottom surface of the magnetic spring magnet 252 is placed on the flange portion 251b. In addition, the hole 251c of the magnetic spring magnet holder 251 is pressed onto the step portion 25c of the tilt shaft 25, and a tip end of the step portion 25c is adhered to the upper surface of the barrel portion 251a. FIG. 11B shows the integrated state of the magnetic spring magnet 252, the magnetic spring magnet holder 251, and the tilt shaft 25. On actual assembly, however, the actuator frame 21 of the outer unit 20 and the tilt coil unit 22 intervene between the magnetic spring magnet holder 251 and the tilt shaft 25.

The tilt shaft 26 is configured in the same manner as the tilt shaft 25. The magnetic spring magnet holder 261 is configured in the same manner as the magnetic spring magnet holder 251. The magnetic spring magnet 262 is configured in the same manner as the magnetic spring magnet 252. The tilt shaft 26, the magnetic spring magnet holder 261, and the magnetic spring magnet 262 are integrated in the same manner as described above.

Returning to FIG. 1, the suspension wires 27a to 27d are made of phosphor bronze, beryllium copper, or the like, and are excellent in conductivity, and have spring property. The suspension wires 27a to 27d have a rectangular cross section. The suspension wires 27a to 27d have the same shape and the same characteristics, and are used to supply an electric current to the pan coils 171 and 181 and the LED 122. The suspension wires 27a to 27d are curved backward in the normal state.

On assembly of the inner unit 10 and the outer unit 20, first, the inner unit 10 is stored in the outer unit 20. From the left side, the step portion 25a of the tilt shaft 25 is passed through the shaft hole 21a of the actuator frame 21, and the step portion 25b is passed through the bearing 110 of the inner unit frame 11. After that, the magnetic spring magnet holder 251 is passed through the step portion 25c of the tilt shaft 25, and adhered and fixed to the tilt shaft 25.

Similarly, from the right side, the step portion 26a of the tilt shaft 26 is passed through the shaft hole 21d of the actuator frame 21, and the step portion 26b is passed through the bearing 110 of the inner unit frame 11. Then, the magnetic spring magnet holder 261 is passed through the step portion 26c of the tilt shaft 26, and adhered and fixed to the tilt shaft 26.

In this state, the tilt shafts 25 and 26 are rotated to adjust the positions of the magnetic spring magnets 252 and 262 in the direction of rotation. Specifically, while the inner unit 10 stands erect in the vertical direction, the positions of the magnetic spring magnets 252 and 262 are adjusted such that the magnetic polar sections of the magnetic spring magnets 252 and 262 are positively opposed to the corresponding magnetic polar sections of the tilt magnets 151 and 161. After the completion of the adjustment, the tilt shafts 25 and 26 are adhered and fixed to the actuator frame 21.

Accordingly, the tilt shafts 25 and 26 and the magnetic spring magnets 252 and 262 are fixed so as not to rotate even when the inner unit frame 11 rotates in the Tilt direction. On the other hand, the tilt magnets 151 and 161 rotate integrally with the inner unit frame 11.

When the inner unit frame 11 does not rotate, the positions of boundaries between the sections in the magnetic spring magnets 252 and 262 are aligned with the positions of boundaries of the sections in the tilt magnets 151 and 161. The polarities of the sections in the magnetic spring magnets 252 and 262 are different from the polarities of the opposed sections in the tilt magnets 151 and 161. Therefore, the tilt magnets 151 and 161 are attracted in the right and left directions, and accordingly, rightward and leftward forces act on the inner unit frame 11. These two forces are in balance with each other. Accordingly, the inner unit frame 11 is supported by the actuator frame 21 without being biased to one of the right and left directions.

When the inner unit 10 is rotatably attached to the outer unit 20, as shown in FIG. 12B, one end each of the suspension wires 27a and 27b is passed through the terminal holes 191b of the suspension wire fixing board 191, and is soldered. In addition, the other ends of the suspension wires 27a and 27b are passed through the two terminal holes 241c of the PSD board 241, and are soldered.

Similarly, one end each of the suspension wires 27c and 27d is passed through the terminal holes 192b of the suspension wire fixing board 192, and is soldered. In addition, the other ends of the suspension wires 27c and 27d are passed through the two terminal holes 241d of the PSD board 241, and are soldered. As shown in FIG. 12A, the suspension wires 27a to 27d are curved backward so as to, when the mirror surface of the mirror 123 is vertical to the horizontal direction, connect the terminal holes 191b and 192b and the terminal holes 241c and 241d without being deformed from the normal state. Accordingly, the suspension wires 27a to 27d can have a length needed to rotate the inner unit frame 11 in the Tilt direction with application of a minimum of unnecessary force to the inner unit frame 11. In addition, the suspension wires 27a to 27d allow supply of an electric current to the pan coils 171 and 181 attached to the inner unit frame 11 and the LED 122.

Although not shown, conductive wires are directly connected from the PSD board 241 to the tilt coils 221 and 231 for supply of an electric current. The tilt coils 221 and 231 are attached to the actuator frame 21 not rotating, and even when the conductive wires are directly connected to the tilt coils 221 and 231, the conductive wires do not affect the rotation of the mirror 123.

Accordingly, the mirror actuator 1 is completely assembled. FIG. 12A is a perspective view of the mirror actuator 1 as seen from the front side, and FIG. 12B is a perspective view of the mirror actuator 1 as seen form the back side. In this state, the inner unit frame 11 is rotatable in the Tilt direction around the tilt shafts 25 and 26. The pan coil units 17 and 18 and the suspension wire fixing boards 191 and 192 rotate in the Tilt direction with the rotation of the inner unit frame 11 in the Tilt direction.

In the assembled state shown in FIGS. 12A and 12B, when an electric current is flown into the pan coils 171 and 181, the pan shaft 12 rotates together with the pan coil units 17 and 18 by electromagnetic drive forces generated on the pan coils 171 and 181 and the pan magnets 131 and 141, and accordingly, the mirror 123 rotates in the Pan direction about the pan shaft 12 as an axis.

When the mirror 123 rotates in the Pan direction, the pan coil units 17 and 18 rotate integrally but the suspension wire fixing boards 191 and 192 do not rotate. Therefore, the suspension wires 19a and 19b and the suspension wires 19c and 19d are placed in twist positions around the pan shaft 12 while being pulled in the longitudinal direction. At that time, since the suspension wires 19a to 19d are not stretched or contracted in the longitudinal direction, the flexible suspension wire fixing boards 191 and 192 are pulled in the upward direction. Accordingly, torque is generated around the pan shaft 12 in the direction opposite to the rotation direction of the mirror 123 in the Pan direction by spring property of the suspension wires 19a to 19d and the suspension wire fixing boards 191 and 192. The rotational moment takes a predetermined value capable of being calculated from the spring constants of the suspension wires 19a to 19d and the suspension wire fixing boards 191 and 192 and the rotating position of the mirror 123 around the pan shaft 12. As described above, when the mirror 123 rotates in the Pan direction, torque is always generated in the opposite direction, and thus by stopping application of an electric current to the pan coils 171 and 181, the mirror 123 is returned to the position before rotation.

In the assembled state shown in FIGS. 12A and 12B, when an electric current is flown into the tilt coils 221 and 231, the inner unit frame 11 rotates in the Tilt direction about the tilt shafts 25 and 26 as axes together with the pan coil units 17 and 18 by electromagnetic drive forces generated on the tilt coils 221 and 231 and the tilt magnets 151 and 161, and accordingly, the mirror 123 rotates in the Tilt direction.

When the inner unit frame 11 rotates in the Tilt direction, the tilt magnet 151 rotates together with the inner unit frame 11, but the magnetic spring magnet 252 does not rotate because the magnetic spring magnet 252 is fixed to the tilt shaft 25. Accordingly, there arises a circumferential shift between the positions of the divided sections in the tilt magnet 151 and the positions of the divided sections in the magnetic spring magnet 252. Thus, a portion of N-pole sections in the tilt magnet 151 is opposed to a portion of N-pole sections in the magnetic spring magnet 252, and a portion of S-pole sections in the tilt magnet 151 is opposed to a portion of the S-pole sections in the magnetic spring magnet 252. This generates magnetic forces on the sections in the tilt magnet 151 to return the tilt magnet 151 to the position before rotation. Accordingly, torque (drag) toward the tilt neutral position is applied to the inner unit frame 11. The torque (drag) takes a predetermined value capable of being calculated from the intensity of a magnetic force generated between the tilt magnet 151 and the magnetic spring magnet 252 and the rotating position of the inner unit frame 11.

As described above, when the mirror 123 rotates from the tilt neutral position integrally with the inner unit frame 11, the opposite torque is always generated, and thus by stopping application of an electric current to the tilt coils 221 and 231, the mirror 123 is returned to the tilt neutral position.

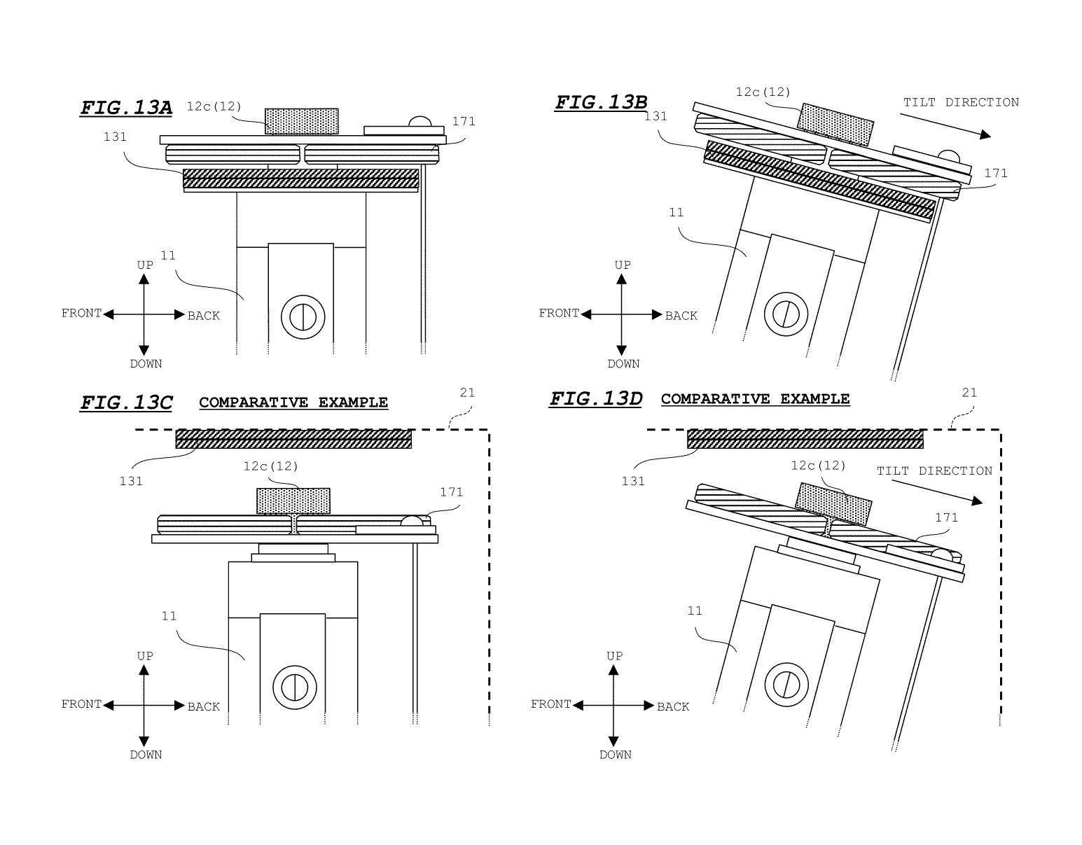

FIG. 13A is a partially enlarged view of the pan magnet 131, the pan coil 171, and their surroundings with the mirror 123 not rotated. FIG. 13B is a partially enlarged view of the pan magnet 131, the pan coil 171, and their surroundings with the mirror 123 rotated in the Tilt direction. FIGS. 13C and 13D show comparative examples in which the actuator frame 21 is extended to the upper portion of the inner unit frame 11 and the pan magnet 131 is fixed to the upper portion of the actuator frame 21. FIG. 13C is a partially enlarged view of the pan magnet 131, the pan coil 171, and their surroundings with the mirror 123 not rotated in the comparative example. FIG. 13D is a partially enlarged view of the pan magnet 131, the pan coil 171, and their surroundings with the mirror 123 rotated in the Tilt direction. Described below is only the position relationship between the pan magnet 131 and the pan coil 171. However, the following description also applies to the position relationship between the pan magnet 141 and the pan coil 181.

Referring to FIG. 13A, when the mirror 123 does not rotate in the Tilt direction, the pan magnet 131 attached to the inner unit frame 11 and the pan coil 171 attached to the pan shaft 12 are arranged one above the other so as to be in parallel with each other with predetermined space therebetween. Therefore, the distance between the pan magnet 131 and the pan coil 171 is almost constant. In addition, the centers of the pan magnet 131 and the pan coil 171 are aligned with each other.

As shown in FIG. 13B, when the mirror 123 rotates in the Tilt direction, the pan magnet 131 and the pan coil 171 rotate integrally with the inner unit frame 11. Therefore, the pan magnet 131 and the pan coil 171 incline from the horizontal plane while being arranged in parallel with each other. Accordingly, even when the inner unit frame 11 rotates in the Tilt direction, the distance between the pan magnet 131 and the pan coil 171 is almost constant as before the rotation. In addition, the centers of the pan magnet 131 and the pan coil 171 remain aligned with each other. Therefore, even when the inner unit frame 11 rotates in the Tilt direction, a stable magnetic field is supplied to the pan coil 171 as before the rotation. Thus, even when the inner unit frame 11 rotates in the Tilt direction, it is possible to properly rotate the mirror 123 in the Pan direction.

On the other hand, in the comparative example shown in FIG. 13C, when the mirror 123 does not rotate in the Tilt direction, the pan magnet 131 and the pan coil 171 are arranged one above the other so as to be parallel with each other, as in the case of FIG. 13A. Therefore, the distance between the pan magnet 131 and the pan coil 171 is almost constant. In addition, the centers of the pan magnet 131 and the pan coil 171 are aligned with each other.

As shown in FIG. 13D, however, when the mirror 123 rotates in the Tilt direction, the pan coil 171 rotates integrally with the inner unit frame 11 but the pan magnet 131 does not rotate because the pan magnet 131 is fixed to the actuator frame 21. Therefore, only the pan coil 171 inclines from the horizontal plane. Thus, while the inner unit frame 11 rotates in the Tilt direction, the distance between the pan magnet 131 and the pan coil 171 becomes larger from the front to back sides. In addition, the center of the pan coil 171 is shifted to the right from the center of the pan magnet 131.

As described above, in the comparative example, when the mirror 123 rotates in the Tilt direction, the distance between the pan magnet 131 and the pan coil 171 becomes larger from the front to back sides, and the intensity of an electromagnetic drive force is different between the front and back sides, and thus an unstable magnetic field is supplied to the pan coil 171. Therefore, in the comparative example, while the inner unit frame 11 rotates in the Tilt direction, when the mirror 123 rotates in the Pan direction, the rotation of the mirror 123 becomes unstable.

As described above, in this embodiment, even when the mirror 123 rotates in the Tilt direction, the distances between the pan magnets 131 and 141 and the pan coils 171 and 181 do not change. Therefore, even when the inner unit frame 11 rotates in any manner in the Tilt direction, the intensities of electromagnetic drive forces generated on the pan magnets 131 and 141 and the pan coils 171 and 181 also do not change.

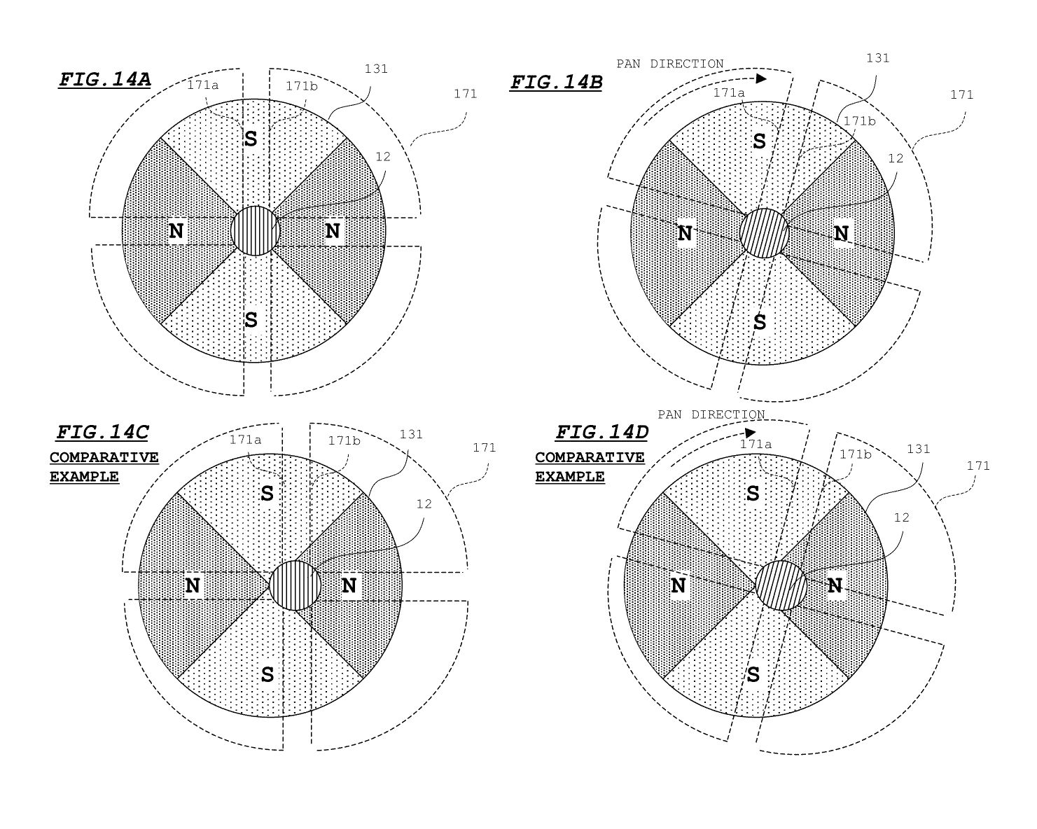

FIGS. 14A and 14B are schematic diagrams showing position relationship between the pan magnet 131 and the pan coil 171 as seen from above when the mirror 123 rotates in the Tilt direction as shown in FIG. 13B. FIGS. 14C and 14D are schematic diagrams showing position relationship between the pan magnet 131 and the pan coil 171 as seen from above when the mirror 123 rotates in the Tilt direction in the comparative example of FIG. 13D. Described below is only the position relationship between the pan magnet 131 and the pan coil 171. However, the following description also applies to the position relationship between the pan magnet 141 and the pan coil 181.

Referring to FIG. 14A, when the mirror 123 does not rotate in the Pan direction, the center of the pan magnet 131 and the center of the pan coil 171 are both positioned on the pan shaft 12 and aligned with each other. In this case, straight portions 171a and 171b of the pan coil 171 are both opposed to only the S poles of the pan magnet 131. In this state, when an electric current is flown into the pan coil 171 and thus passed through the straight portions 171a and 171b in the same direction, even drive forces are generated on the straight portions 171a and 171b in the same direction. By the drive forces, the pan coil 171 rotates in the Pan direction and enters the state shown in FIG. 14B.

In the state shown in FIG. 14B, the center of the pan magnet 131 and the center of the pan coil 171 are also both positioned on the pan shaft 12 and aligned with each other. In this case, the straight portions 171a and 171b of the pan coil 171 are also both opposed only to the S poles of the pan magnet 131. Thus, when an electric current is further supplied to the pan coil 171 in this state, stable drive forces are excited on the straight portions 171a and 171b. Accordingly, in this embodiment, even when the mirror 123 rotates in the Tilt direction and rotates in the Pan direction, stable drive forces are excited on the straight portions 171a and 171b.

On the other hand, in the comparative example, when the inner unit frame 11 rotates in the Tilt direction as shown in FIG. 13D, the center of the pan coil 171 is shifted from the center of the pan magnet 131 fixed to the actuator frame 21 as shown in FIG. 14C. In this case, the straight portion 171a of the pan coil 171 is opposed only to the S poles of the pan magnet 131, while the straight portion 171b is partially opposed to the N poles. In this state, when an electric current is flown into the pan coil 171, uneven drive forces are generated on the straight portion 171a and the straight portion 171b. Accordingly, a drive force applied to the pan coil 171 becomes unstable.

When the inner unit frame 11 further rotates and the position relationship between the pan coil 171 and the pan magnet 131 enters the state shown in FIG. 14D, the center of the pan coil 171 is more largely shifted from the center of the pan magnet 131. In this case, the straight portion 171a of the pan coil 171 remains opposed only to the S poles of the pan magnet 131, while the straight portion 171b is more largely opposed to the N poles of the pan magnet 131 than before the rotation in the Pan direction. When an electric current is flown into the pan coil 171 in this state, further uneven drive forces are generated on the straight portion 171a and the straight portion 171b. Accordingly, a drive force applied to the pan coil 171 becomes further unstable.

As described above, in the comparative example, when the inner unit frame 11 rotates in the Tilt direction, the position relationship between the pan magnet 131 and the pan coil 171 changes to cause an unstable drive force to be applied to the pan coil 171. Therefore, while the inner unit frame 11 rotates in the Tilt direction, when the mirror 123 rotates in the Pan direction, the rotation of the mirror 123 becomes unstable. In addition, since a drive force applied to the pan coil 171 varies with changes in the rotating position of the inner unit frame 11, it is difficult to control the mirror 123 in the Pan direction.

In contrast, in this embodiment, even when the mirror 123 rotates in the Tilt direction, the position relationship between the pan magnet 131 and the pan coil 171 does not change. Therefore, even while the mirror 123 rotates in the Tilt direction, the mirror 123 can be stably rotated in the Pan direction. In addition, it is possible to easily control the mirror 123 in the Pan direction.

The pan magnets 131 and 141 and the tilt magnets 151 and 161 are almost circular in shape, and the pan coils 171 and 181 and the tilt coils 221 and 231 are almost circular in shape. Accordingly, even when the mirror 123 rotate in the Tilt direction or the Pan direction, there is little change in the areas of portions in which the pan magnets 131 and 141 and the pan coils 171 and 181 are opposed to each other, and there is little change in the areas of portions in which the tilt magnets 151 and 161 and the tilt coils 221 and 231 are opposed to each other. Therefore, it is possible to apply an even rotational force to the mirror 123 for stable rotation.

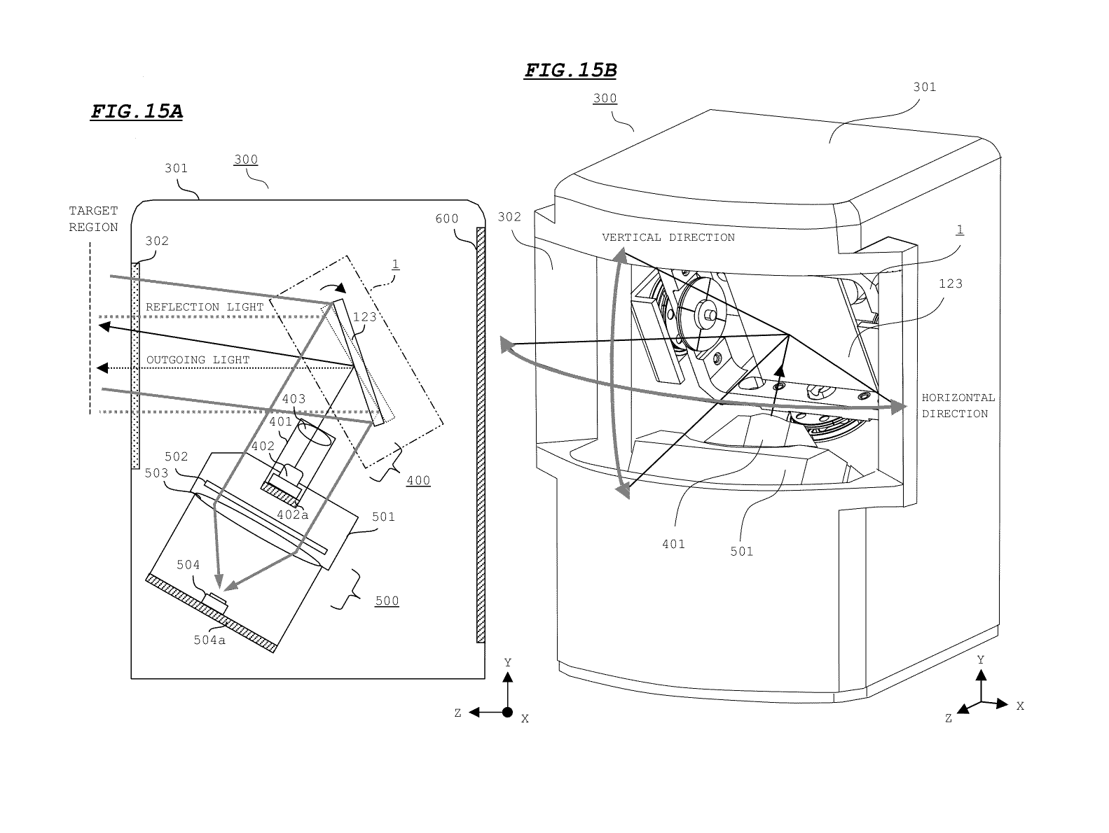

FIGS. 15A and 15B are diagrams showing a configuration of a laser radar 300 to which the mirror actuator 1 according to the embodiment is attached.

FIG. 15A is a perspective lateral view of an interior of the laser radar 300, and FIG. 15B is a perspective outer view of the laser radar 300.

Referring to FIG. 15A, the laser radar 300 includes a housing 301, a projection/light-receiving window 302, a projection unit 400, a light-receiving unit 500, and a circuit board 600.

The housing 301 has a cubic shape and stores therein the projection unit 400, the light-receiving unit 500, and the circuit board 600. The projection/light-receiving window 302 is attached to the front side of the housing 301.

The projection/light-receiving window 302 is formed by a curved transparent plate as shown in FIG. 15B. The projection/light-receiving window 302 is made of a highly transparent material and has an anti-reflection film (AR coat) applied to the incidence plane and the outgoing plane thereof.

The projection unit 400 includes a laser holder 401, a laser light source 402, a beam shaping lens 403, and the mirror actuator 1.

The laser holder 401 is formed in the shape of a cylinder larger in diameter than the laser light source 402 and the beam shaping lens 403, and holds therein the laser light source 402, and has the beam shaping lens 403 attached to the front surface thereof.

The laser light source 402 emits laser light with a wave length of about 900 nm. The laser light source 402 is arranged such that the outgoing direction of laser light is inclined toward the mirror 123 from a vertical direction (Y-axis forward direction), with respect to an in-plane direction on a YZ plane to widen the range of scanning a target region with the laser light by the rotation of the mirror 123 in the Pan direction. The laser light source 402 is electrically connected to the circuit board 402a.

The beam shaping lens 403 is attached to the laser holder 401 such that an optical axis of the beam shaping lens 403 is aligned with an outgoing optical axis of the laser source 402. In addition, the beam shaping lens 403 allows outgoing laser light to converge into a predetermined shape in the target region. For example, the beam shaping lens 403 is designed such that the shape of a beam in the target region (in this embodiment, the target region is set at a position of about several tens meters forward of the projection/light-receiving window 302) is an oval about 2 m high and 0.2 m wide.

The mirror actuator 1 is disposed such that, when the mirror 123 is in the neutral position, the incident angle formed by the mirror surface of the mirror 123 in the mirror actuator 1 and the laser light emitted from the laser light source 402 is a predetermined angle (for example, 60 degrees). The “neutral position” here refers to a position in which the mirror 123 is not rotated by the mirror actuator 1 but is vertical to the front-back direction of FIG. 1. In the neutral position, the laser light from the beam shaping lens 403 enters almost the center of the mirror 123.

The light-receiving unit 500 includes a lens barrel 501, a bandbass filter 502, a light-receiving lens 503, and a light detector 504.

The lens barrel 501 has the bandpass filter 502, the light-receiving lens 503, and the light detector 504 attached to the inside thereof.

The bandpass filter 502 is formed by a dielectric multi-layer film to let pass only light with a wavelength band of outgoing laser light. The bandpass filter 502 is formed by a simple film because reflection light enters the bandpass filter 502 in almost parallel state.

The light-receiving lens 503 is a Fresnel lens which collects light reflected from the target region. The Fresnel lens is formed by dividing a convex lens into concentric sections to reduce thickness.

The light detector 504 is formed by an APD (avalanche photodiode) or a PIN photodiode, and is attached to the circuit board 504a. The light detector 504 outputs an electric signal of a magnitude according to the amount of received light to the circuit board 504a. A light-receiving surface of the light detector 504 is not divided into a plurality of sections but is a single light-receiving surface. In addition, the light-receiving surface of the light detector 504 is configured to be made smaller in height and width (for example, about 1 mm) to suppress influence of stray light.

The laser light emitted from the laser light source 402 is converged by the beam shaping lens 403 and formed into a predetermined shape in the target region. The laser light having passed through the beam shaping lens 403 enters the mirror 123 of the mirror actuator 1 and is reflected by the mirror 123 toward the target region.

As shown in FIG. 15B, when the mirror 123 is driven by the mirror actuator 1 in the Pan direction and the Tilt direction, the emitted laser light scans the target region. The laser light scans the target region along a plurality of scanning lines parallel to the X-Z plane. To scan with the laser light along the scanning lines, the mirror 123 is driven in the Pan direction and the Tilt direction. In addition, to change the scanning lines, the mirror 123 is driven in the Tilt direction.

Returning to FIG. 15A, the reflection light from the target region travels backward the light path of the emitted laser light traveling toward the target region, and enters the mirror 123. The reflection light incident on the mirror 123 is reflected by the mirror 123, and then enters the light-receiving lens 503 through a gap between the laser holder 401 and the lens barrel 501.

The foregoing behavior of the reflection light is the same even when the mirror 123 is in any rotating position. Specifically, even when the mirror 123 is in any rotating position, the reflection light from the target region moves backward the light path of the outgoing laser light, travels parallel to the optical axis of the beam shaping lens 403, and enters the light-receiving lens 503.

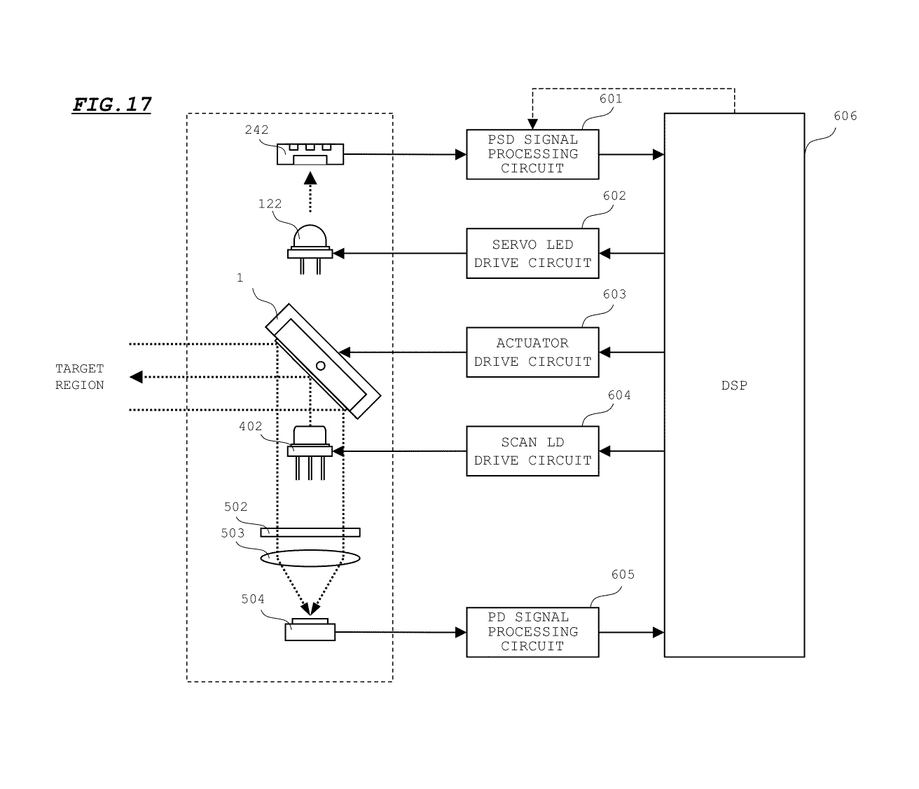

The circuit board 600 is electrically connected to the circuit board 402a for the laser light source 402, the circuit board 504a for the light detector 504, and the PSD board 241 of the mirror actuator 1. The circuit board 600 includes a CPU, a memory, and others to control the laser light source 402 and the mirror actuator 1. Further, the circuit board 600 detects the presence or absence of an object in the target region and measures the distance from the laser radar 300 to the object according to a signal from the light detector 504. Specifically, the circuit board 600 measures the distance from the laser radar 300 to the object by a time difference between the timing when the laser light is emitted and the timing when the signal is output from the light detector 504. A circuit configuration of the laser radar 300 will be described later with reference to FIG. 17.

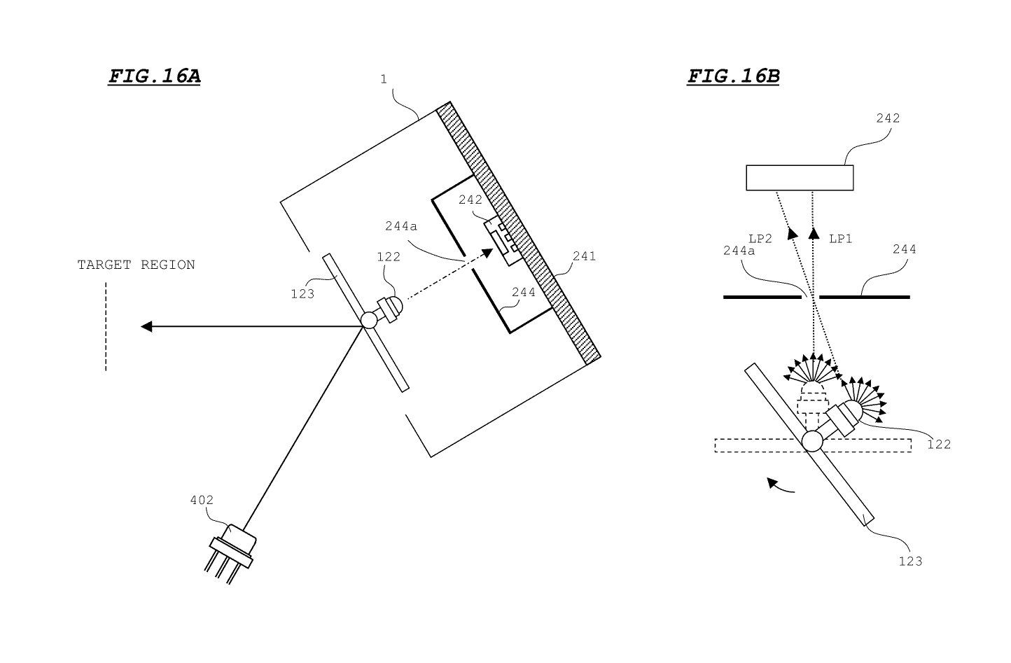

FIGS. 16A and 16B are diagrams for describing a servo optical system to detect the position of the mirror 123. FIG. 16A shows only a partial cross section of the mirror actuator 1 and the laser light source 402.

Referring to FIG. 16A, as described above, the mirror actuator 1 includes the LED 122, the pinhole box 244, the PSD board 241, and the PSD 242.

The LED 122, the PSD 242, and the pin hole 244a are arranged such that, when the mirror 123 of the mirror actuator 1 is in the neutral position, the LED 122 faces the centers of the pin hole 244a of the pin hole box 244 and the PSD 242. Specifically, the pinhole box 244 and the PSD 242 are arranged such that, when the mirror 123 is in the neutral position, servo light emitted from the LED 122 and passed through the pin hole 244a enters vertically the center of the PSD 242. The pinhole box 244 is also arranged in a position closer to the PSD 242 than an intermediate position between the LED 122 and the PSD 242.

A portion of the servo light emitted so as to be diffused from the LED 122 passes through the pin hole 244a and is received by the PSD 242. The servo light incident on a region other than the pin hole 244a is blocked out by the pin hole box 244. The PSD 242 outputs an electric signal according to the light-receiving position of the servo light.

For example, when the mirror 123 rotates in the direction of an arrow from the neutral position shown by broken lines in FIG. 16B, the light path of light of the diffused light (servo light) from the LED 122 passing through the pin hole 244a changes from LP1 to LP2. As a result, the irradiating position of the servo light on the PSD 242 changes, and thus a position detection signal output from the PSD 242 also changes. In this case, there is one-on-one correspondence between the light-emitting position of the servo light from the LED 122 and the incidence position of the servo light on the light-receiving surface of the PSD 242. Therefore, it is possible to detect the position of the mirror 123 by the incidence position of the servo light detected by the PSD 242. As a result, it is possible to detect the scanning position of the scanning laser light in the target region.

FIG. 17 is a diagram showing a circuit configuration of the laser radar 300. For the sake of convenience, FIG. 17 also shows a major configuration of the laser radar 300. As shown in FIG. 17, the laser radar 300 includes a PSD signal processing circuit 601, a servo LED drive circuit 602, an actuator drive circuit 603, a scan LD drive circuit 604, a PD signal processing circuit 605, and a DSP 606.

The PSD signal processing circuit 601 outputs to the DSP 606 a position detection signal determined based on an output signal from the PSD 242. The servo LED drive circuit 602 supplies a drive signal to the LED 122 based on the signal from the DSP 606. The actuator drive circuit 603 drives the mirror actuator 1 based on the signal from the DSP 606. Specifically, a drive signal for scanning the target region with the laser light along a predetermined path is supplied to the mirror actuator 1.

The scan LD drive circuit 604 supplies a drive signal to the laser light source 402 based on the signal from the DSP 606. Specifically, the scan LD drive circuit 604 supplies a pulsed drive signal (current signal) to the laser light source 402 at a timing when the laser light is irradiated to the target region.

The PD signal processing circuit 605 amplifies and digitizes a voltage signal according to the amount of light received by the light detector 504, and supplies the same to the DSP 606.

The DSP 606 detects the scanning position of the laser light in the target region based on the position detection signal input from the PSD signal processing circuit 601, and executes drive control on the mirror actuator 1, drive control on the laser light source 402, and others. The DSP 606 also determines whether an object exists at the laser light irradiation position in the target region based on the voltage signal input from the PD signal processing circuit 605. At the same time, the DSP 606 measures the distance from the laser radar 300 to the object based on a time difference between the irradiation timing of the laser light output from the laser light source 402 and the light-receiving timing of the reflection light from the target region received by the light detector 504.

As described above, according to this embodiment, it is possible to stably rotate the mirror 123 in the Pan direction while rotating the mirror 123 in the Tilt direction.

In addition, according to this embodiment, the pan magnets 131 and 141 and the tilt magnets 151 and 161 are formed in an almost circular shape, and the pan coils 171 and 181 and the tilt coils 221 and 231 are also formed in an almost circular shape. Therefore, it is possible to rotate the mirror 123 in a more stable manner.

As in the foregoing, the embodiment of the present invention is described. However, the present invention is not limited to the foregoing embodiment, and the embodiment of the present invention can be modified in various manners other than the foregoing one.

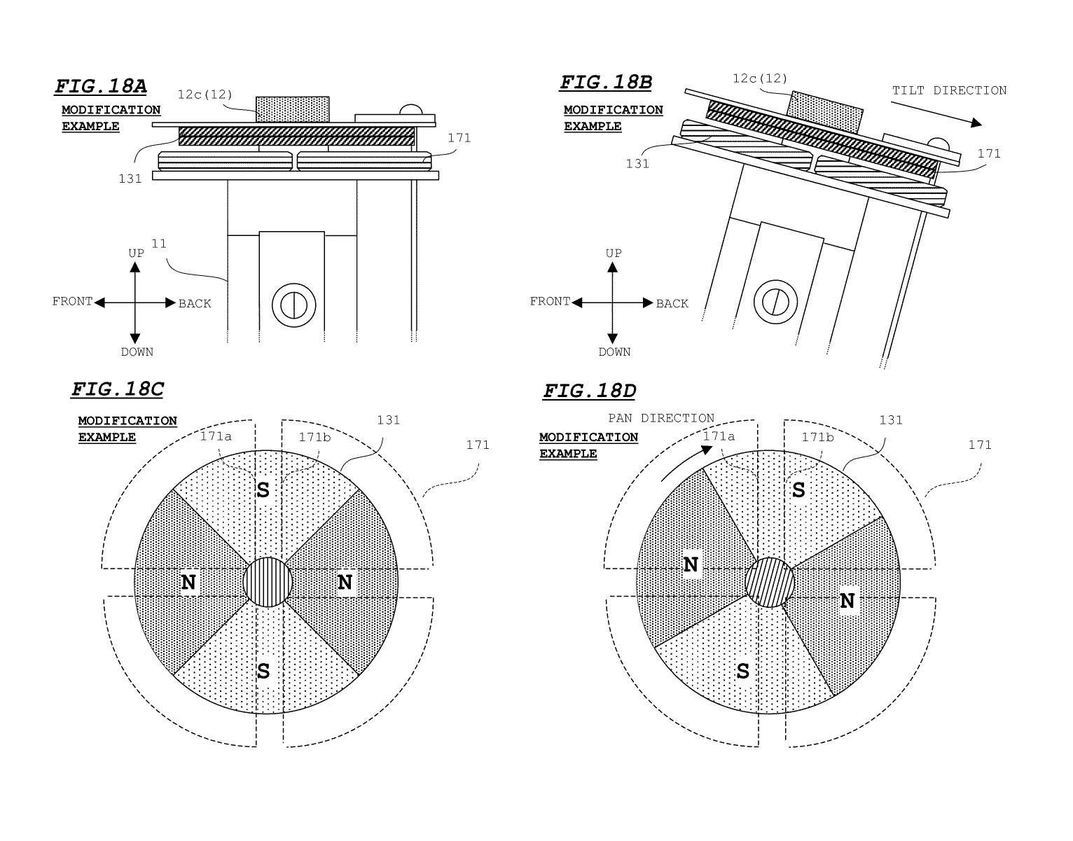

For example, in the foregoing embodiment, the so-called moving coil-type drive portion is used in which the pan magnets 131 and 141 are fixed and the pan coils 171 and 181 are rotated. However, as shown in a modification example of FIGS. 18A to 18D, the present invention may be used for a moving magnet-type drive portion.

FIGS. 18A to 18D are diagrams of modification examples. FIGS. 18A and 18B are schematic diagrams showing the position relationship between the pan magnet 131 and the pan coil 171 as seen from the front side. FIGS. 18C and 18D are schematic diagrams showing the position relationship between the pan magnet 131 and the pan coil 171 as seen from above. Described below is only the position relationship between the pan magnet 131 and the pan coil 171. However, the following description also applies to the position relationship between the pan magnet 141 and the pan coil 181.

Referring to FIG. 18A, the pan magnet 131 is attached so as to be rotatable integrally with the pan shaft 12, and the pan coil 171 is attached so as to be rotatable integrally with the inner unit frame 11.

As shown in FIG. 18B, in this modification example, even when the mirror 123 rotates in the Tilt direction, the position relationship between the pan magnet 131 and the pan coil 171 does not change as in the foregoing embodiment.

Referring to FIG. 18C, when the mirror 123 does not rotate in the Pan direction, the center of the pan magnet 131 and the center of the pan coil 171 are both positioned on the pan shaft 12 and aligned with each other. In this case, the straight portions 171a and 171b of the pan coil 171 are both opposed to only the S poles of the pan magnet 131. When an electric current is flown into the pan coil 171 in this state, even drive forces are generated on the straight portions 171a and 171b in the same direction.

FIG. 18D shows the state in which the pan magnet 131 rotates in the Pan direction by the foregoing drive forces. In this case, the center of the pan magnet 131 and the center of the pan coil 171 are also both positioned on the pan shaft 12 and aligned with each other. In addition, the straight portions 171a and 171b of the pan coil 171 are also both opposed only to the S poles of the pan magnet 131.

Therefore, in the configuration of this modification example, even when the mirror 123 rotates in the Tilt direction and rotates in the Pan direction, a magnetic field similar to that before the rotation is applied to the straight portions 171a and 171b. Accordingly, at the rotation of the mirror 123, stable drive forces are excited on the straight portions 171a and 171b, and a stable drive force is applied to the pan magnet 131 by a reaction force to the foregoing drive forces.

As described above, in this modification example, it is possible to stably rotate the mirror 123 in the Pan direction while rotating the mirror 123 in the Tilt direction, as in the foregoing embodiment.

In the foregoing embodiment, the pan magnets 131 and 141 and the tilt magnets 151 and 161 are each divided into four sections, but may be divided into two sections instead.

In the foregoing embodiment, the pan magnets 131 and 141 and the tilt magnets 151 and 161 are circular in shape, but may be square in shape instead. Nevertheless, the pan magnets 131 and 141 and the tilt magnets 151 and 161 are rotated and thus are desirably circular in shape as in the foregoing embodiment.

In the foregoing embodiment, the four pan coils 171 are electrically connected into one. Alternatively, the four pan coils 171 may be electrically separated from each other and individually supplied with an electric current. Similarly, the four pan coils 181 may be separated from each other. In the description of Claim 3, the term “a plurality of coils” includes the mode in which the coils are electrically connected to each other and the mode in which the coils are separated from each other. In addition, the numbers of the pan coils 171 and 181 are not limited to four but may be two or other. Specifically, the numbers of the pan coils 171 and 181 can be changed as appropriate according to the numbers of sections of magnetic poles of the pan magnets 131 and 141. Further, the shape of the pan coils 171 and 181 is not limited to the fan shape but may be any other shape as far as the straight portions are positioned at the corresponding magnetic poles. The foregoing matters also apply to the tilt coils 221 and 231.

In addition, in the foregoing embodiment, the four suspension wires 19a to 19d with circular cross sections are used to supply an electric current to the pan coils 171 and 181 and the LED 122. However, the number of the suspension wires is not limited to this. For example, additional suspension wires not for use as current supply may be arranged in the foregoing embodiment. In addition, the suspension wires 19a to 19d may be rectangular in cross section.

Further, in the foregoing embodiment, the diffusion-type (wide-oriented type) LED 122 is used as a light source for diffusing and emitting servo light. However, a non-diffusion-type LED may be used instead. In this case, a diffusion lens with the function of light diffusion may be arranged at the light outgoing side of the non-diffusion-type LED. Alternatively, the non-diffusion-type LED may be covered with a cap with the function of light diffusion.

Moreover, in the foregoing embodiment, the mirror actuator 1 is configured such that the inner unit frame 11 rotates in the Tilt direction and the mirror 123 rotates in the Pan direction with respect to the inner unit frame 11. Alternatively, the mirror actuator 1 may be configured such that the inner unit frame 11 rotates in the Pan direction and the mirror 123 rotates in the Tilt direction with respect to the inner unit frame 11.

Besides, the embodiment of the present invention can be modified as appropriate in various manners within the scope of technical ideas described in the claims.

What is claimed is:

1. A mirror actuator, comprising:
a base;
a first rotation portion that is supported on the base so as to be rotatable about a first rotation axis;
a second rotation portion that is supported on the first rotation portion so as to be rotatable about a second rotation axis perpendicular to the first rotation axis;
a mirror disposed at the second rotation portion;
a first drive portion that rotates the first rotation portion around the first rotation axis; and
a second drive portion that rotates the second rotation portion around the second rotation axis, wherein
the second drive portion has a coil part and a magnet part applying a magnetic field to the coil part, and
one of the coil part and the magnet part is disposed at the first rotation portion, and the other is disposed at the second rotation portion.

2. The mirror actuator according to claim 1, wherein
the second rotation portion includes a shaft part that is supported on the first rotation portion so as to be rotatable about the second rotation axis,
the mirror is attached to the shaft part,
the coil part is disposed at one of the shaft part and the first rotation portion, and
the magnet part is disposed at the other of the shaft part and the first rotation portion.

3. The mirror actuator according to claim 2, wherein
the magnet part includes a magnet with divided magnetic poles around the second rotation axis,
the coil part includes a plurality of coils including straight portions radially extending from the second rotation axis, the plurality of coils being formed such that the adjacent straight portions are opposed to one of the magnetic poles of the magnet, and
the coils and the magnet are arranged at predetermined intervals in a direction parallel to the second rotation axis.

4. The mirror actuator according to claim 3, wherein the magnet part is formed such that an outer periphery thereof has a circular shape centered at the second rotation axis.

5. The mirror actuator according to claim 1, wherein
the coil part is disposed at the second rotation portion, and
the magnet part is disposed at the first rotation portion.

6. A beam irradiation device, comprising:
a mirror actuator; and
a laser light source that supplies laser light to a mirror of the mirror actuator, wherein
the mirror actuator includes:
a base;
a first rotation portion that is supported on the base so as to be rotatable about a first rotation axis;
a second rotation portion that is supported on the first rotation portion so as to be rotatable about a second rotation axis perpendicular to the first rotation axis;
a mirror disposed at the second rotation portion;
a first drive portion that rotates the first rotation portion around the first rotation axis; and
a second drive portion that rotates the second rotation portion around the second rotation axis, wherein
the second drive portion has a coil part and a magnet part applying a magnetic field to the coil part, and
one of the coil part and the magnet part is disposed at the first rotation portion, and the other is disposed at the second rotation portion.

7. The beam irradiation device according to claim 6, wherein
the second rotation portion includes a shaft part that is supported on the first rotation portion so as to be rotatable about the second rotation axis,
the mirror is attached to the shaft part,
the coil part is disposed at one of the shaft part and the first rotation portion, and
the magnet part is disposed at the other of the shaft part and the first rotation portion.

8. The beam irradiation device according to claim 7, wherein
the magnet part includes a magnet with divided magnetic poles around the second rotation axis,
the coil part includes a plurality of coils including straight portions radially extending from the second rotation axis, the plurality of coils being formed such that the adjacent straight portions are opposed to one of the magnetic poles of the magnet, and
the coils and the magnet are arranged at predetermined intervals in a direction parallel to the second rotation axis.

9. The beam irradiation device according to claim 8, wherein the magnet part is formed such that an outer periphery thereof has a circular shape centered at the second rotation axis.

10. The beam irradiation device according to claim 6, wherein
the coil part is disposed at the second rotation portion, and
the magnet part is disposed at the first rotation portion.

11. A laser radar, comprising:
a mirror actuator;
a laser light source that supplies laser light to a mirror of the mirror actuator;
a light-receiving portion that receives the laser light reflected from a target region; and
a detection portion that detects an object in the target region based on an output from the light-receiving portion, wherein
the mirror actuator includes:
a base;
a first rotation portion that is supported on the base so as to be rotatable about a first rotation axis;
a second rotation portion that is supported on the first rotation portion so as to be rotatable about a second rotation axis perpendicular to the first rotation axis;
a mirror disposed at the second rotation portion;
a first drive portion that rotates the first rotation portion around the first rotation axis; and
a second drive portion that rotates the second rotation portion around the second rotation axis, wherein
the second drive portion has a coil part and a magnet part applying a magnetic field to the coil part, and
one of the coil part and the magnet part is disposed at the first rotation portion, and the other is disposed at the second rotation portion

12. The laser radar according to claim 11, wherein
the second rotation portion includes a shaft part that is supported on the first rotation portion so as to be rotatable about the second rotation axis,
the mirror is attached to the shaft part,
the coil part is disposed at one of the shaft part and the first rotation portion, and
the magnet part is disposed at the other of the shaft part and the first rotation portion.

13. The laser radar according to claim 12, wherein
the magnet part includes a magnet with divided magnetic poles around the second rotation axis,
the coil part includes a plurality of coils including straight portions radially extending from the second rotation axis, the plurality of coils being formed such that the adjacent straight portions are opposed to one of the magnetic poles of the magnet, and
the coils and the magnet are arranged at predetermined intervals in a direction parallel to the second rotation axis.

14. The laser radar according to claim 13, wherein the magnet part is formed such that an outer periphery thereof has a circular shape centered at the second rotation axis.

15. The laser radar according to claim 11, wherein
the coil part is disposed at the second rotation portion, and
the magnet part is disposed at the first rotation portion.
